(19) United States
(12) Patent Application Publication
(10) Pub. No.: US 2008/0261114 A1
(43) Pub. Date: Oct. 23, 2008

(54) ANODE ACTIVE MATERIAL AND SECONDARY BATTERY

(75) Inventor: Hidetaka Ishihara, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/107,219

(22) Filed: Apr. 22, 2008

(30) Foreign Application Priority Data
Apr. 23, 2007 (JP) 2007-113015
Feb. 14, 2008 (JP) 2008-033343

(51) Int. Cl. H01M 4/66

(52) U.S. Cl. 429/221; 429/223; 429/231.8; 429/231.5

(57) ABSTRACT

A secondary battery having a high capacity and superior cycle characteristics and an anode active material used for it are provided. The anode active material contains, as an element, at least tin (Sn), iron (Fe), cobalt (Co), and carbon (C). A carbon content is in the range from 11.9 wt % to 29.7 wt %, a total ratio of iron and cobalt to a total of tin, iron, and cobalt is in the range from 26.4 wt % to 48.5 wt %, and a cobalt ratio to a total of iron and cobalt is in the range from 9.9 wt % to 79.5 wt %. A reactive phase capable of reacting with an electrode reactant is included. A half-width of a diffraction peak obtained by X-ray diffraction (peak observed at diffraction angle 2θ of between 41 degrees and 45 degrees) is 1.0 degree or more.

### CROSS REFERENCES TO RELATED APPLICATIONS

The present invention contains subject matter related to Japanese Patent Application JP 2007-113015 filed in the Japanese Patent Office on Apr. 23, 2007, and Japanese Patent Application JP 2008-033343 filed in the Japanese Patent Office on Feb. 14, 2008, the entire contents of which being incorporated herein by references.

### BACKGROUND OF THE INVENTION

1. Field of the Invention

The present invention relates to an anode active material containing tin, iron, cobalt, and carbon as an element and a secondary battery using it.

2. Description of the Related Art

In recent years, many portable electronic devices such as combination cameras (videotape recorder), mobile phones, and notebook personal computers have been introduced, and their size and weight have been reduced. Since a battery used as a portable power source for these electronic devices, in particular a secondary battery is important as a key device, research and development to improve the energy density have been actively promoted. Specially, a nonaqueous electrolyte secondary battery (for example, lithium ion secondary battery) is able to provide a higher energy density compared to a lead battery and a nickel cadmium battery as an existing aqueous electrolytic solution secondary battery. Thus, studies of improving such a nonaqueous electrolyte secondary battery have been made in various fields.

In the lithium ion secondary battery, as an anode active material, a carbon material such as non-graphitizable carbon and graphite that shows the relatively high capacity and has the favorable cycle characteristics has been widely used. However, since a higher capacity has been demanded in recent years, the capacity of the carbon material should be more improved.

Against such a background, techniques to achieve a high capacity with the use of the carbon material by selecting the carbonized raw material and the forming conditions have been developed (for example, refer to Japanese Unexamined Patent Application Publication No. 8-315825). However, in the case of using such a carbon material, the anode discharge potential is in the range from 0.8 V to 1.0 V to lithium, and the battery discharge voltage becomes lowered in the case of structuring the secondary battery. Thus, in this case, it is not possible to expect great improvement of the battery energy density. Further, in this case, there is a disadvantage that the hysteresis is large in the charge and discharge curved line shape, and the energy efficiency in each charge and discharge cycle is low.

Meanwhile, as an anode with the capacity higher than that of the carbon material, researches on an alloy material have been promoted. In such an alloy material, the fact that a certain type of metal is electrochemically alloyed with lithium, and the resultant alloy is reversibly generated and decomposed is applied. For example, a high capacity anode using Li—Al alloy or Sn alloy has been developed. Further, a high capacity anode made of Si alloy has been developed (for example, refer to U.S. Pat. No. 4,950,566).

However, the Li—Al alloy, the Sn alloy, or the Si alloy is expanded and shrunk due to charge and discharge, the anode is pulverized every time charge and discharge are repeated, and thus the cycle characteristics are extremely poor.

Thus, as a technique to improve the cycle characteristics, studies on inhibiting expansion by alloying tin or silicon have been made. For example, it has been proposed to alloy a transition metal such as iron and cobalt and tin (for example, refer to Japanese Unexamined Patent Application Publication Nos. 2004-022306, 2004-063400, 2005-078999, 2006-107792, 2006-128051, and 2006-344403; “Journal of the Electrochemical Society,” 1999, No. 146, p. 405, “Journal of the Electrochemical Society,” 1999, No. 146, p. 414, and “Journal of the Electrochemical Society,” 1999, No. 146, p. 423). Further, Mg₂Si or the like has been proposed (for example, refer to “Journal of the Electrochemical Society,” 1999, No. 146, p. 4401). In addition, for example, Sn·A·X (A represents at least one of transition metals and X represents at least one selected from the group consisting of carbon and the like) in which the Sn/(Sn+A+V) ratio is in the range from 20 atomic % to 80 atomic % (for example, refer to Japanese Unexamined Patent Application Publication No. 2000-311681), and a substance in which a metal compound (A₁₋ₓBₓ: A is tin, silicon or the like; and B is iron, cobalt or the like) that is alloyed with a carbon material capable of inserting and extracting lithium is dispersed in the carbon material (for example, refer to Japanese Unexamined Patent Application Publication No. 2004-349253) have been proposed.

### SUMMARY OF THE INVENTION

However, even if the foregoing technique is used, in the present circumstances, the effects of improving the cycle characteristics are not sufficient, and the advantages of the high capacity anode using the alloy material are not sufficiently used. Thus, a technique to more improve the cycle characteristics has been sought.

In view of the foregoing, in the invention, it is desirable to provide a secondary battery having a high capacity and superior cycle characteristics and an anode active material used for it.

According to an embodiment of the invention, there is provided an anode active material containing, as an element, at least tin, iron, cobalt, and carbon. The carbon content is in the range from 11.9 wt % to 29.7 wt %, the total ratio of iron and cobalt to the total of tin, iron, and cobalt is in the range from 26.4 wt % to 48.5 wt %, and the cobalt ratio to the total of iron and cobalt is in the range from 9.9 wt % to 79.5 wt %. The anode active material has a reactive phase capable of reacting with an electrode reactant. A half-width of a diffraction peak obtained by X-ray diffraction (the peak observed at a diffraction angle 2θ of between 41 degrees and 45 degrees) is 1.0 degree or more.

According to an embodiment of the invention, there is provided a secondary battery including a cathode, an anode, and an electrolyte. The anode contains an anode active material containing, as an element, at least tin, iron, cobalt, and carbon. The carbon content in the anode active material is in the range from 11.9 wt % to 29.7 wt %. The total ratio of iron and cobalt to the total of tin, iron, and cobalt is in the range from 26.4 wt % to 48.5 wt %. The cobalt ratio to the total of iron and cobalt is in the range from 9.9 wt % to 79.5 wt %. The anode active material has a reactive phase capable of reacting with an electrode reactant. A half-width of a diffraction peak obtained by X-ray diffraction (the peak observed at the diffraction angle 2θ of between 41 degrees and 45 degrees) is 1.0 degree or more.

The anode active material according to the embodiment of the invention has the reactive phase capable of reacting with the electrode reactant and the half-width of the diffraction peak obtained by X-ray diffraction (the peak observed at the diffraction angle 2θ of between 41 degrees and 45 degrees) is 1.0 degree or more. In this case, since the anode active material contains tin as an element, a high capacity may be obtained. Further, the anode active material contains iron and cobalt as an element, the total ratio of iron and cobalt to the total of tin, iron, and cobalt is in the range from 26.4 wt % to 48.5 wt %, and the cobalt ratio to the total of iron and cobalt is in the range from 9.9 wt % to 79.5 wt %. Thus, while the high capacity is retained, the cycle characteristics are improved. Further, since the anode active material contains carbon as an element, and the carbon content is in the range from 11.9 wt % to 29.7 wt %, the cycle characteristics are more improved. In the result, according to the secondary battery of the embodiment of the invention using the anode active material, a high capacity may be obtained, and superior cycle characteristics may be obtained.

Further, if the anode active material contains at least one selected from the group consisting of aluminum, titanium, vanadium, chromium, niobium, and tantalum; or if the anode active material contains at least one selected from the group consisting of nickel, copper, zinc, gallium, and indium; or if the anode active material contains the both thereof, the cycle characteristics may be more improved. In particular, in the case that the anode active material contains the both thereof, if the content of the former element is from 0.1 wt % to 9.9 wt % and the content of the latter element is from 0.5 wt % to 14.9 wt %, higher effects are obtainable.

Furthermore, if the anode active material contains silver as an element, the cycle characteristics may be more improved. In particular, if the content is in the range from 0.1 wt % to 9.9 wt %, higher effects are obtainable.

In addition, if the anode active material contains at least one selected from the group consisting of aluminum, titanium, vanadium, chromium, niobium, and tantalum; at least one selected from the group consisting of nickel, copper, zinc, gallium, and indium; and silver, the cycle characteristics may be more improved.

Other and further objects, features and advantages of the invention will appear more fully from the following description.

### BRIEF DESCRIPTION OF THE DRAWINGS

FIG. 1 is a cross section showing a structure of a first secondary battery according to an embodiment of the invention;

FIG. 2 is a cross section showing an enlarged part of the spirally wound electrode body shown in FIG. 1;

FIG. 3 is an exploded perspective view showing a structure of a second secondary battery according to the embodiment of the invention;

FIG. 4 is a cross section showing a structure taken along line IV-IV of the spirally wound electrode body shown in FIG. 3;

FIG. 5 is a cross section showing a structure of a third secondary battery according to the embodiment of the invention;

FIG. 6 is a diagram showing an example of peaks obtained by X-ray Photoelectron Spectroscopy for an anode active material formed in an example;

FIG. 7 is a cross section showing a structure of a coin type secondary battery formed in examples;

FIG. 8 is a characteristics diagram showing a relation between a carbon content in an anode active material and a capacity retention ratio/an initial charge capacity;

FIG. 9 is a diagram showing an example of a peak obtained by X-ray Photoelectron Spectroscopy for an anode active material formed in a comparative example;

FIG. 10 is a characteristics diagram showing a relation between a total ratio of iron and cobalt to a total of tin, iron, and cobalt in an anode active material and a capacity retention ratio/an initial charge capacity;

FIG. 11 is characteristics diagram showing a relation between a cobalt ratio to a total of iron and cobalt in an anode active material and a capacity retention ratio/an initial charge capacity;

FIG. 12 is a characteristics diagram showing a relation between a titanium content in an anode active material and a capacity retention ratio/an initial charge capacity;

FIG. 13 is a characteristics diagram showing a relation between a copper content in an anode active material and a capacity retention ratio/an initial charge capacity;

FIG. 14 is a characteristics diagram showing a relation between a silver content in an anode active material and a capacity retention ratio/an initial charge capacity; and

FIG. 15 is a characteristics diagram showing a relation between a half-width of a diffraction peak obtained by X-ray diffraction and a capacity retention ratio/an initial charge capacity.

### DETAILED DESCRIPTION OF THE PREFERRED EMBODIMENT

An embodiment of the invention will be hereinafter described in detail with reference to the drawings.

An anode active material according to an embodiment of the invention is capable of reacting with an electrode reactant such as lithium, and contains tin, iron, and cobalt as elements (first to third elements). Tin has the high reaction amount of lithium per unit weight, and a high capacity is thereby obtainable. It is difficult to obtain sufficient cycle characteristics with the use of simple substance of tin. Meanwhile, if the anode active material contains iron and cobalt, the cycle characteristics are improved.

For the iron content and the cobalt content, the total ratio of iron and cobalt to the total of tin, iron, and cobalt is preferably in the range from 26.4 wt % to 48.5 wt %, and more preferably in the range from 29.2 wt % to 48.5 wt %. If such a total ratio is low, the iron content and the cobalt content are lowered and thus, it is difficult to achieve sufficient cycle characteristics. Meanwhile, if such a total ratio is high, the tin content is lowered and thus, it is difficult to obtain a capacity higher than that of the existing anode material such as a carbon material.

Further, for the cobalt content, the cobalt ratio to the total of iron and cobalt is preferably in the range from 9.9 wt % to 79.5 wt %, and more preferably in the range from 29.5 wt % to 79.5 wt %. If such a ratio is low, the cobalt content is lowered and thus, it is difficult to achieve sufficient cycle characteristics. Meanwhile, if such a ratio is high, the tin content is lowered and thus, it is difficult to obtain a capacity higher than that of the existing anode material such as a carbon material.

The anode active material further contains carbon as an element (forth element) in addition to tin, iron, and cobalt. Thereby, the cycle characteristics are more improved.

The carbon content is preferably in the range from 11.9 wt % to 29.7 wt %, more preferably in the range from 14.9 wt % to 29.7 wt %, and much more preferably in the range from 17.8 wt % to 29.7 wt %. In such a range, high effects are obtainable.

In particular, the anode active material preferably further contains at least one selected from the group consisting of aluminum, titanium, vanadium, chromium, niobium, and tantalum as an element (fifth element) in addition to tin, iron, cobalt, and carbon. Thereby, the cycle characteristics are more improved.

Further, the anode active material preferably further contains at least one selected from the group consisting of nickel, copper, zinc, gallium, and indium as an element (sixth element). Thereby, the cycle characteristics are more improved.

The anode active material may contain only the fifth element, may contain only the sixth element, or may contain the both thereof, in addition to the first to the fourth elements. In this case, if the anode active material contains both the fifth element and the sixth element, higher effects are obtainable. In particular, if the anode active material contains both the fifth element and the sixth element, the content of the fifth element is preferably in the range from 0.1 wt % to 9.9 wt %, and the content of the sixth element is preferably in the range from 0.5 wt % to 14.9 wt %. Thereby, higher effects are obtainable.

In addition, the anode active material preferably further contains silver as an element (seventh element) in addition to tin, iron, cobalt, and carbon. Thereby, the cycle characteristics are more improved.

The silver content is preferably in the range from 0.1 wt % to 9.9 wt %, and more preferably in the range from 0.9 wt % to 9.9 wt %. In such a range, higher effects are obtainable.

The anode active material may contain only the fifth and the sixth elements, may contain only the seventh element, or may contain all thereof, in addition to the first to the fourth elements. In this case, if the anode active material contains all thereof, higher effects are obtainable.

The anode active material has a low crystallinity phase or an amorphous phase. The phase is a reactive phase capable of reacting with lithium or the like, and superior cycle characteristics are thereby obtained. The reactive phase include, for example, the above-mentioned elements and becomes low crystal or amorphous mainly by carbon. The diffraction peak obtained by X-ray diffraction of the phase has the diffraction angle 2θ of between 20 degrees and 50 degrees, where CuKα-ray is used as a specific X ray and the sweep rate is 1 degree/min. Whether or not the diffraction peak obtained by X-ray diffraction corresponds to the reaction phase capable of reacting with lithium or the like is easily determined by comparison between the X-ray diffraction chart before the electrochemical reaction with lithium or the like and the X-ray diffraction chart after the electrochemical reaction with lithium or the like. For example, if the position of the diffraction peak before the electrochemical reaction with lithium or the like and the position of the diffraction peak after the electrochemical reaction with lithium or the like are different from each other, the diffraction peak obtained by X-ray diffraction corresponds to the reaction phase capable of reacting with lithium or the like.

The half-width of the diffraction peak obtained by X-ray diffraction of the anode active material (the peak observed at the diffraction angle 2θ of between 41 degrees and 45 degrees) is 1.0 degree or more, where CuKα-ray is used as a specific X ray and the sweep rate is 1 degree/min. Thereby, lithium or the like is more smoothly inserted and extracted, and the reactivity with an electrolyte is more reduced.

The definition of the half-width of the diffraction peak to which the foregoing range (1.0 degree or more) is applied is as follows. As described above, the broad diffraction peak of the reactive phase occurs in the range of 2θ=from 20 to 50 degrees. In the diffraction peak, 2 clear peaks exist in the vicinity of 30 degrees and in the vicinity of 43 degrees. At this time, the diffraction peak to which the foregoing range (1.0 degree or more) is applied is the peak in the vicinity of 43 degrees (from 41 to 45 degrees). To obtain the half-width of the peak, the peak of from 41 to 45 degrees is provided with fitting by using the base line of the broad peak observed in the range from 20 degrees to 50 degrees as the basis, and then the peak width in the height where the peak intensity becomes a half value is calculated. The peak of between 41 degrees and 45 degrees exists after the electrode reaction, and the peak intensity thereof do not change after the electrode reaction. Therefore, the above-mentioned half-width is reproducibly calculated from the X-ray diffraction result and whether or not the half-width falls within the above-mentioned range (1.0 degree or more) is stably checked.

In some cases, the anode active material has a phase containing the simple substance of each element or part thereof, in addition to the foregoing low crystallinity phase or the foregoing amorphous phase.

Further, in the anode active material, at least part of carbon as an element is preferably bonded to a metal element or a metalloid element as other element. Lowering of cycle characteristics may be caused by cohesion or crystallization of tin or the like. In this regard, if carbon is bonded to other element, such cohesion or crystallization is prevented.

As a measurement method for examining bonding state of elements, for example, X-ray Photoelectron Spectroscopy (XPS) is cited. In the XPS, a sample is irradiated with soft X-ray (in a commercially available apparatus, Al—Kα-ray or Mg—Kα-ray is used), the kinetic energy of photoelectrons jumped out from the surface thereof is measured, and thereby the element composition and the bonding state in the region several nm apart from the sample surface are examined.

The bound energy of the inner orbital electron of an element varies in correlation with the charge density on the element first approximately. For example, in the case where the charge density of carbon element is decreased due to interaction with an element existing in the vicinity thereof, an outer shell electron such as 2p electron is decreased, and thus 1s electron of the carbon element is strongly bound by the shell. That is, if an electric charge of an element is decreased, the bound energy is increased. In XPS, if the bound energy is increased, the peak is shifted to the higher energy region.

In XPS, in the case of graphite, the peak of 1s orbit of carbon (C1s) is observed at 284.5 eV in the apparatus in which energy calibration is made so that the peak of 4f orbit of gold atom (Au4f) is obtained in 84.0 eV. In the case of surface contamination carbon, the peak is observed at 284.8 eV. Meanwhile, in the case of higher charge density of carbon element, for example, if carbon is bonded to an element more positive than carbon, the peak of C1s is observed in the region lower than 284.5 eV. That is, in the case where at least part of carbon contained in the anode active material is bonded to the metal element, the metalloid element or the like as other element, the peak of the composite wave of C1s obtained for the anode active material is observed in the region lower than 284.5 eV.

In XPS measurement of the anode active material, if the surface is covered with surface contamination carbon, the surface is preferably slightly sputtered with the use of an argon ion gun attached to an XPS apparatus. Further, in the case where the anode active material subject to measurement exists in the anode of the after-mentioned secondary battery, it is preferable that after the secondary battery is disassembled and the anode is taken out, the anode is washed with a volatile solvent such as dimethyl carbonate. Thereby, a low-volatile solvent and an electrolyte salt that exist on the surface of the anode are removed. Such a sampling is desirably made under the inert atmosphere.

Further, in XPS measurement, for example, the peak of C1s is used for correcting the energy axis of spectrums. Since surface contamination carbon generally exists on a substance surface, the peak of C1s of the surface contamination carbon is set to 284.8 eV, which is used as an energy reference. In the XPS measurement, the waveform of the peak of C1s is obtained as a form including the peak of the surface contamination carbon and the peak of carbon in the anode active material. Therefore, for example, by performing analysis by using commercially available software, the peak of the surface contamination carbon and the peak of carbon in the anode active material are separated. In the analysis of the waveform, the position of the main peak existing on the lowest bound energy side is set to the energy reference (284.8 eV).

The anode active material is formed by, for example, mixing raw materials of the respective elements, melting the mixture in an electric furnace, a high frequency inducing furnace, an arc melting furnace or the like, and then solidifying the resultant. Otherwise, the anode active material is formed by, for example, various atomization methods such as gas atomization method and water atomization method, various rolling methods, or a method utilizing mechanochemical reaction such as mechanical alloying method and mechanical milling method. Specially, the anode active material is preferably formed by the method utilizing mechanochemical reaction, since the anode active material thereby obtain the low crystallinity structure or the amorphous structure. For such a method, for example, a planetary ball mill device may be used.

For the raw material, simple substances of the respective elements may be used by mixing. However, for part of the elements other than carbon, alloys are preferably used. When carbon is added to such alloys, and then the anode active material is synthesized by a method using mechanical alloying method, the low crystallinity structure or the amorphous structure is obtainable, and the reaction time is reduced. The raw materials may be either powder or a mass.

As a carbon used as a raw material, for example, one or more carbon materials such as non-graphitizable carbon, graphitizable carbon, graphite, pyrolytic carbons, coke, glassy carbons, an organic polymer compound fired body, activated carbon, and carbon black may be used. Of the foregoing, the coke includes pitch coke, needle coke, petroleum coke and the like. The organic polymer compound fired body is a carbonized body obtained by firing a polymer compound such as a phenol resin and a furan resin at an appropriate temperature. The shape of these carbon materials may be fibrous, spherical, granular, or scale-like.

The anode active material is used for a secondary battery as follows, for example.

### First Secondary Battery

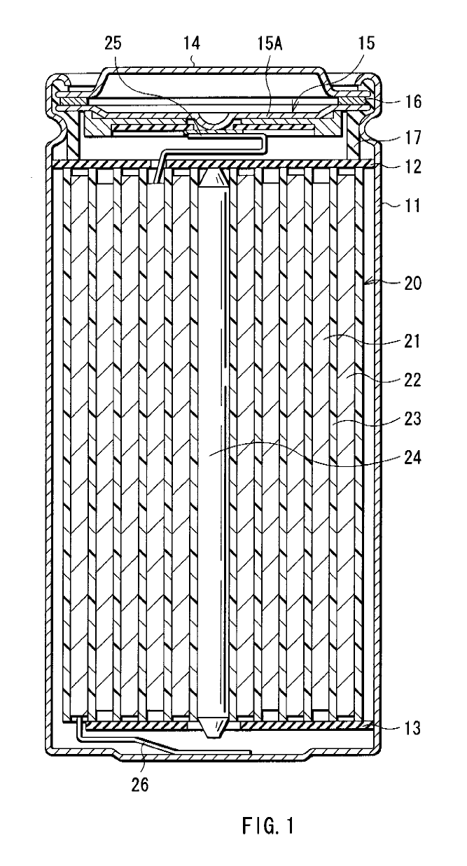

FIG. 1 shows a cross sectional structure of a first secondary battery. The secondary battery herein described is, for example, a lithium ion secondary battery in which the anode capacity is expressed as the capacity based on insertion and extraction of lithium as an electrode reactant.

The secondary battery contains a spirally wound electrode body 20 in which a strip-shaped cathode 21 and a strip-shaped anode 22 are layered with a separator 23 in between and spirally wound inside a battery can 11 in the shape of an approximately hollow cylinder. The battery structure including the battery can 11 is called cylindrical type. The battery can 11 is made of, for example, iron plated by nickel. One end of the battery can 11 is closed, and the other end thereof is opened. A liquid electrolyte (so-called electrolytic solution) is injected into the battery can 11 and impregnated in the separator 23. A pair of insulating plates 12 and 13 is respectively arranged perpendicularly to the spirally wound periphery face so that the spirally wound electrode body 20 is sandwiched between the insulating plates 12 and 13.

At the open end of the battery can 11, a battery cover 14, and a safety valve mechanism 15 and a PTC (Positive Temperature Coefficient) device 16 provided inside the battery cover 14 are attached by being caulked with a gasket 17. Inside of the battery can 11 is thereby hermetically sealed. The battery cover 14 is made of, for example, a material similar to that of the battery can 11. The safety valve mechanism 15 is electrically connected to the battery cover 14 through the PTC device 16. In the safety valve mechanism 15, if the internal pressure of the secondary battery becomes a certain level or more by internal short circuit, external heating or the like, a disk plate 15A flips to cut the electric connection between the battery cover 14 and the spirally wound electrode body 20. When temperature rises, the PTC device 16 increases the resistance value and thereby limits a current to prevent abnormal heat generation resulting from a large current. The gasket 17 is made of, for example, an insulating material and its surface is coated with asphalt.

For example, the spirally wound electrode body 20 is spirally wound centering on a center pin 24. A cathode lead 25 made of aluminum (Al) or the like is connected to the cathode 21 of the spirally wound electrode body 20, and an anode lead 26 made of nickel (Ni) or the like is connected to the anode 22. The cathode lead 25 is electrically connected to the battery cover 14 by being welded to the safety valve mechanism 15. The anode lead 26 is welded and thereby electrically connected to the battery can 11.

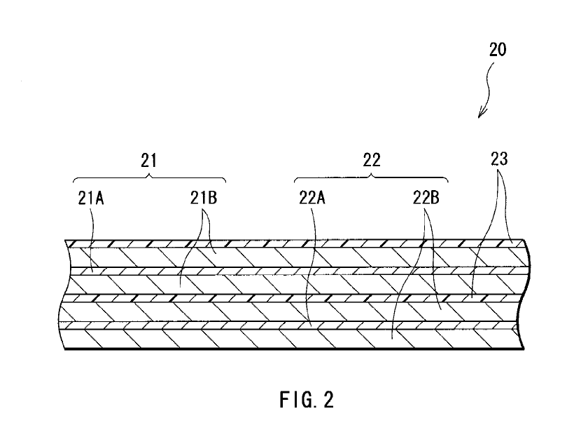

FIG. 2 shows an enlarged part of the spirally wound electrode body 20 shown in FIG. 1. The cathode 21 has a structure in which, for example, a cathode active material layer 21B is provided on a single face or the both faces of a cathode current collector 21A having a pair of opposed faces. The cathode current collector 21A is made of, for example, a metal foil such as an aluminum foil. The cathode active material layer 21B contains, for example, one or more cathode active materials capable of inserting and extracting lithium. If necessary, the cathode active material layer 21B may contain an electrical conductor such as a carbon material and a binder such as polyvinylidene fluoride.

As the cathode active material capable of inserting and extracting lithium, for example, a metal sulfide, a metal oxide or the like not containing lithium such as titanium sulfide (TiS₂), molybdenum sulfide (MoS₂), niobium selenide (NbSe₂), and vanadium oxide (V₂O₅) is cited. Further, a lithium complex oxide having a main body of LiₓMO₂ (in the formula, M represents one or more transition metals, x varies according to charge and discharge states of the secondary battery, and the value of x is generally in the range of 0.05≦x≦1.1) or the like is cited as well. As the transition metal M composing the lithium complex oxide, cobalt, nickel, or manganese (Mn) is preferable. As specific examples of such a lithium complex oxide, LiCoO₂, LiNiO₂, LiₓNi_{y}Co_{1-y}O₂ (in the formula, x and y vary according to charge and discharge states of the secondary battery, and are generally in the range of 0<x<1, 0<y<1), a lithium manganese complex oxide having a spinel structure or the like is cited.

The anode 22 has a structure in which, for example, an anode active material layer 22B is provided on a single face or the both faces of an anode current collector 22A having a pair of opposed faces as the cathode 21 does. The anode current collector 22A is made of, for example, a metal foil such as a copper foil.

The anode active material layer 22B contains, for example, the anode active material according to this embodiment. If necessary, the anode active material layer 22B contains a binder such as polyvinylidene fluoride. Since the anode active material according to this embodiment is contained in the anode active material layer 22B, in the secondary battery, a high capacity is obtainable, and the cycle characteristics and the initial charge and discharge efficiency are improved. The anode active material layer 22B may contain other anode active material and other material such as an electrical conductor in addition to the anode active material according to this embodiment. Other anode active materials include, for example, a carbon material capable of inserting and extracting lithium. The carbon material is preferably used, since the carbon material may improve the charge and discharge cycle characteristics, and functions as an electrical conductor. Examples of the carbon material include, for example, a material similar to that used in forming the anode active material.

The ratio of the carbon material is preferably in the range from 1 wt % to 95 wt % to the anode active material of this embodiment. If the amount of the carbon material is small, the electric conductivity of the anode 22 may be lowered. Meanwhile, if the amount of the carbon material is large, the capacity may be lowered.

The separator 23 separates the cathode 21 from the anode 22, and passes lithium ions while preventing current short circuit due to contact of the both electrodes. The separator 23 is made of, for example, a porous film made of a synthetic resin such as polytetrafluoroethylene, polypropylene, and polyethylene, or a ceramics porous film. The separator 23 may have a structure in which two or more porous films as the foregoing porous films are layered.

The electrolytic solution impregnated in the separator 23 contains a solvent and an electrolyte salt dissolved in the solvent. Examples of the solvent include propylene carbonate, ethylene carbonate, diethyl carbonate, dimethyl carbonate, 1,2-dimethoxyethane, 1,2-diethoxyethane, γ-butyrolactone, tetrahydrofuran, 2-methyltetrahydrofuran, 1,3-dioxolane, 4-methyl-1,3-dioxolane, diethyl ether, sulfolane, methyl sulfolane, acetonitrile, propionitrile, anisole, ester acetate, ester butylate, and ester propionate. One of the solvents may be used singly, or two or more thereof may be used by mixing.

The solvent more preferably contains a cyclic ester carbonate derivative having a halogen atom. Since thereby decomposition reaction of the solvent in the anode 22 may be prevented, the cycle characteristics may be improved. Specific examples of such an ester carbonate derivative include 4-fluoro-1,3-dioxolane-2-one shown in Chemical formula 1, 4-difluoro-1,3-dioxolane-2-one shown in Chemical formula 2, 4,5-difluoro-1,3-dioxolane-2-one shown in Chemical formula 3, 4-difluoro-5-fluoro-1,3-dioxolane-2-one shown in Chemical formula 4, 4-chrolo-1,3-dioxolane-2-one shown in Chemical formula 5, 4,5-dichrolo-1,3-dioxolane-2-one shown in Chemical formula 6, 4-bromo-1,3-dioxolane-2-one shown in Chemical formula 7, 4-iodine-1,3-dioxolane-2-one shown in Chemical formula 8, 4-fluoromethyl-1,3-dioxolane-2-one shown in Chemical formula 9, 4-trifluoromethyl-1,3-dioxolane-2-one shown in Chemical formula 10 and the like. Specially, 4fluoro-1,3-dioxolane-2-one is desirable, since higher effects are thereby obtainable.

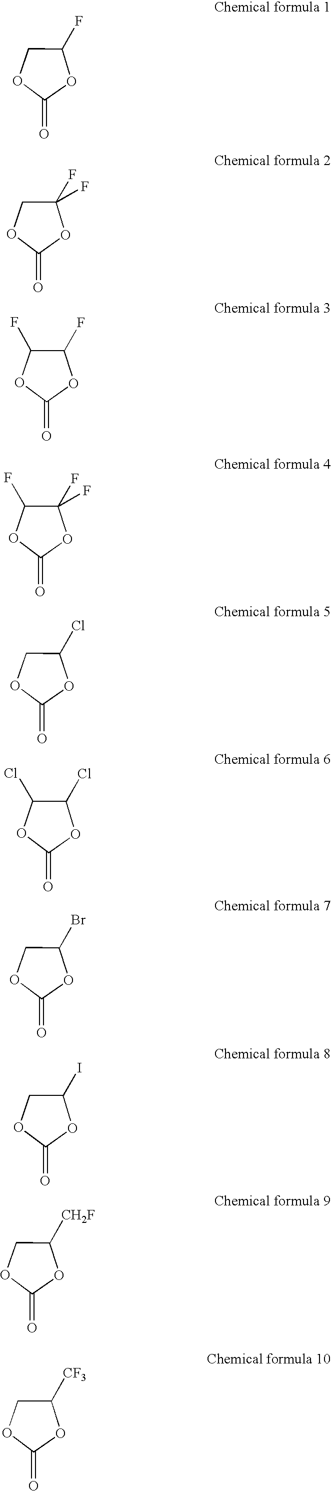

The solvent may be composed of only the ester carbonate derivative. However, the solvent is preferably a mixture of the ester carbonate derivative and a low-boiling point solvent having a boiling point of 150 deg C. or less at the ambient pressure (1.01325×10⁵ Pa), since thereby the ion conductivity is improved. The content of ester carbonate derivative is preferably in the range from 0.1 wt % to 80 wt % to the entire solvent. If the content is small, the effects to prevent the decomposition reaction of the solvent in the anode 22 may be insufficient. Meanwhile, if the content is large, the viscosity may be increased, and thus the ion conductivity may be lowered.

As the electrolyte salt, for example, a lithium salt is cited. One thereof may be used singly, or two or more thereof may be used by mixing. Examples of the lithium salt include LiClO₄, LiAsF₆, LiPF₆, LiBF₄, LiB(C₆H₅)₄, CH₃SO₃Li, CF₃SO₃Li, LiCl, LiBr and the like. Though the lithium salt is preferably used as an electrolyte salt, it is not absolutely necessary to use the lithium salt. Lithium ions contributing to charge and discharge are enough if provided by the cathode 21 or the like.

The secondary battery is manufactured, for example, as follows.

First, for example, a cathode active material, and if necessary, an electrical conductor and a binder are mixed to prepare a cathode mixture. After that, the cathode mixture is dispersed in a mixed solvent such as N-methyl-2-pyrrolidone to form cathode mixture slurry. Subsequently, the cathode current collector 21A is coated with the cathode mixture slurry, which is dried and compressed to form the cathode active material layer 21B, and thereby the cathode 21 is formed. After that, the cathode lead 25 is welded to the cathode 21.

Further, for example, the anode active material according to this embodiment and if necessary, other anode active material and a binder are mixed to prepare an anode mixture. The anode mixture is dispersed in a mixed solvent such as N-methyl-2-pyrrolidone to form anode mixture slurry. Subsequently, the anode current collector 22A is coated with the anode mixture slurry, which is dried and compressed to form the anode active material layer 22B, and thereby the anode 22 is formed. After that, the anode lead 26 is welded to the anode 22.

Subsequently, the cathode 21 and the anode 22 are spirally wound with the separator 23 in between. An end of the cathode lead 25 is welded to the safety valve mechanism 15, and an end of the anode lead 26 is welded to the battery can 11. The spirally wound cathode 21 and the spirally wound anode 22 are sandwiched between the pair of insulating plates 12 and 13, and are contained in the battery can 11. Subsequently, an electrolytic solution is injected into the battery can 11. After that, at the open end of the battery can 11, the battery cover 14, the safety valve mechanism 15, and the PTC device 16 are fixed by being caulked with the gasket 17. The secondary battery shown in FIG. 1 and FIG. 2 is thereby fabricated.

In the secondary battery, when charged, for example, lithium ions are extracted from the cathode 21, and are inserted in the anode 22 through the electrolyte. When discharged, for example, lithium ions are extracted from the anode 22, and are inserted in the cathode 21 through the electrolyte.

As above, the anode active material according to this embodiment has the reactive phase capable of reacting with an electrode reactant, and the half-width of the diffraction peak obtained by X-ray diffraction (the peak observed at the diffraction angle 2θ of between 41 degrees and 45 degrees) is 1.0 degree or more. In this case, since the anode active material contains tin as the first element, the high capacity is obtainable. Further, the anode active material contains iron and cobalt as the second element and the third element, the total ratio of iron and cobalt to the total of tin, iron, and cobalt is in the range from 26.4 wt % to 48.5 wt %, and the cobalt ratio to the total of iron and cobalt is in the range from 9.9 wt % to 79.5 wt %. Thus, the cycle characteristics are improved. Further, the anode active material contains carbon as the forth element, and the carbon content is in the range from 11.9 wt % to 29.7 wt %. Thus, the cycle characteristics are more improved. Thereby, compared to a case in which the iron content is smaller than the cobalt content, while the high capacity is retained, the cycle characteristics are largely improved. Therefore, according to the secondary battery using the foregoing anode active material, a high capacity is obtainable, and superior cycle characteristics are obtainable.

Further, in the case where the anode active material contains at least one selected from the group consisting of aluminum, titanium, vanadium, chromium, niobium, and tantalum as the fifth element, or in the case where the anode active material contains at least one selected from the group consisting of nickel, copper, zinc, gallium, and indium as the sixth element, the cycle characteristics may be more improved. In this case, if the anode active material contains both the fifth element and the sixth element, higher effects are obtainable. In particular, in the case where the anode active material contains both the fifth element and the sixth element, the content of the fifth element is in the range from 0.1 wt % to 9.9 wt %, and the content of the sixth element is in the range from 0.5 wt % to 14.9 wt %, higher effects are obtainable.

Furthermore, if the anode active material contains silver as the seventh element, the cycle characteristics may be more improved. In particular, if the silver content is in the range from 0.1 wt % to 9.9 wt %, higher effects are obtainable.

In addition, if the anode active material contains all of the fifth to the seventh elements, the cycle characteristics may be more improved

### Second Secondary Battery

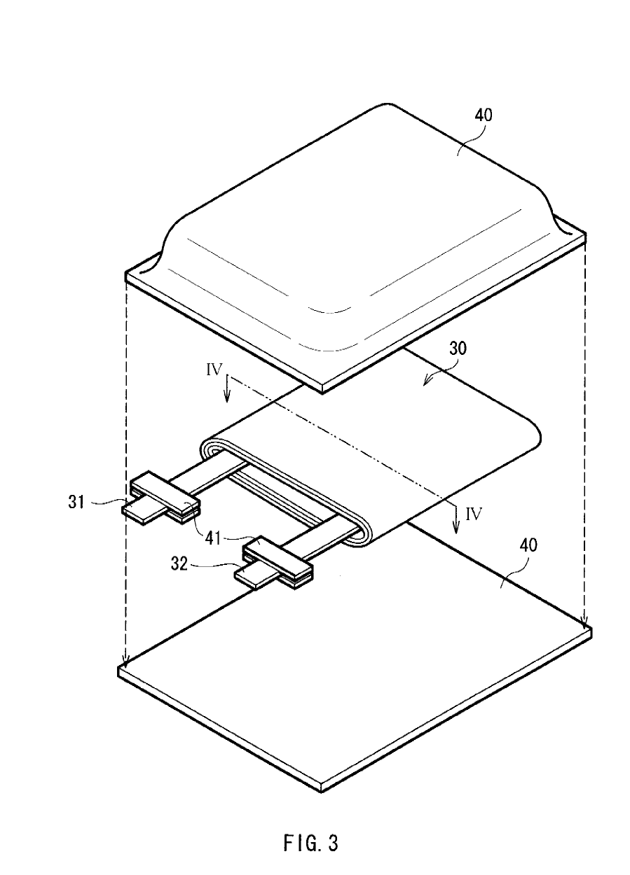

FIG. 3 shows an exploded perspective structure of a second secondary battery. In the secondary battery, a spirally wound electrode body 30 on which a cathode lead 31 and an anode lead 32 are attached is contained in a film package member 40. The size, the weight, and the thickness of the secondary battery may be reduced. The secondary battery is, for example, a lithium ion secondary battery similar to the first secondary battery, and the battery structure including the film package member 40 is called the laminated film type.

The cathode lead 31 and the anode lead 32 are respectively directed from inside to outside of the package member 40 in the same direction, for example. The cathode lead 31 and the anode lead 32 are made of, for example, a metal material such as aluminum, copper, nickel, and stainless, and are respectively in the shape of a thin plate or mesh.

The package member 40 is made of a rectangular aluminum laminated film in which, for example, a nylon film, an aluminum foil, and a polyethylene film are bonded together in this order. The package member 40 is, for example, arranged so that the polyethylene film side and the spirally wound electrode body 30 are opposed, and the respective outer edges are contacted to each other by fusion bonding or an adhesive. An adhesive film 41 to protect from entering of outside air is inserted between the package member 40 and the cathode lead 31, the anode lead 32. The adhesive film 41 is made of a material having contact characteristics to the cathode lead 31 and the anode lead 32, for example, is made of a polyolefin resin such as polyethylene, polypropylene, modified polyethylene, and modified polypropylene.

The package member 40 may be made of a laminated film having other structure, a polymer film such as polypropylene, or a metal film, instead of the foregoing aluminum laminated film.

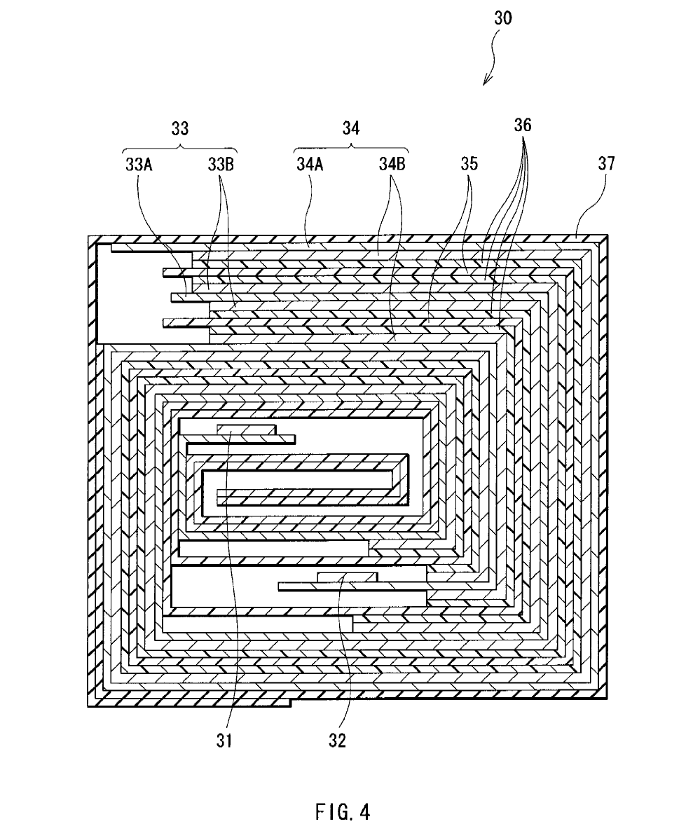

FIG. 4 shows a cross sectional structure taken along line IV-IV of the spirally wound electrode body 30 shown in FIG. 3. In the spirally wound electrode body 30, a cathode 33 and an anode 34 are layered with a separator 35 and an electrolyte layer 36 in between and then spirally wound. The outermost periphery thereof is protected by a protective tape 37.

The cathode 33 has a structure in which a cathode active material layer 33B is provided on a single face or the both faces of a cathode current collector 33A. The anode 34 has a structure in which an anode active material layer 34B is provided on a single face or the both faces of an anode current collector 34A. Arrangement is made so that the anode active material layer 34B side is opposed to the cathode active material layer 33B. The structures of the cathode current collector 33A, the cathode active material layer 33B, the anode current collector 34A, the anode active material layer 34B, and the separator 35 are similar to those of the cathode current collector 21A, the cathode active material layer 21B, the anode current collector 22A, the anode active material layer 22B, and the separator 23 of the foregoing first secondary battery.

The electrolyte layer 36 is so-called gelatinous, containing an electrolytic solution and a polymer compound that holds the electrolytic solution. The gel electrolyte is preferable, since thereby high ion conductivity is obtainable and liquid leakage of the secondary battery may be prevented. The structure of the electrolytic solution (that is, a solvent and an electrolyte salt) is similar to that of the electrolytic solution in the foregoing first secondary battery. As the polymer compound, for example, a fluorinated polymer compound such as polyvinylidene fluoride and a copolymer of vinylidene fluoride and hexafluoropropylene, an ether polymer compound such as polyethylene oxide and a cross-linked compound containing polyethylene oxide, or polyacrylonitrile is cited. In particular, in terms of redox stability, the fluorinated polymer compound is desirable.

Instead of the electrolyte layer 36 in which the electrolytic solution is held by the polymer compound, the electrolytic solution may be directly used. In this case, the electrolytic solution is impregnated in the separator 35.

The secondary battery including the gel electrolyte layer 36 is manufactured, for example, as follows.

First, a precursor solution containing a solvent, an electrolyte salt, a polymer compound, and a mixed solvent is prepared. After that, the cathode 33 and the anode 34 are respectively coated with the precursor solution and the mixed solvent is volatilized to thereby form the electrolyte layer 36. Subsequently, the cathode lead 31 is attached to an end of the cathode current collector 33A by welding, and the anode lead 32 is attached to an end of the anode current collector 34A by welding. Subsequently, the cathode 33 and the anode 34 formed with the electrolyte layer 36 are layered with the separator 35 in between to obtain a laminated body. After the laminated body is spirally wound in the longitudinal direction, the protective tape 37 is adhered to the outermost periphery thereof to form the spirally wound electrode body 30. Finally, for example, the spirally wound electrode body 30 is sandwiched between the package members 40, and outer edges of the package members 40 are contacted by thermal fusion bonding or the like to enclose the spirally wound electrode body 30. At this time, the adhesive film 41 is inserted between the cathode lead 31/the anode lead 32 and the package member 40. Thereby, the secondary battery shown in FIG. 3 and FIG. 4 is fabricated.

Otherwise, the secondary battery including the gel electrolyte layer 36 may be manufactured as follows. First, the cathode 33 and the anode 34 are formed as described above, and the cathode lead 31 and the anode lead 32 are respectively attached on the cathode 33 and the anode 34. After that, the cathode 33 and the anode 34 are layered with the separator 35 in between and spirally wound. The protective tape 37 is adhered to the outermost periphery thereof, and thereby a spirally wound body as a precursor of the spirally wound electrode body 30 is formed. Subsequently, the spirally wound body is sandwiched between the package members 40, the peripheral edges other than one side are contacted by thermal fusion-bonding or the like to obtain a pouched state, and the spirally wound body is contained in the package member 40. Subsequently, a composition of matter for electrolyte containing a solvent, an electrolyte salt, a monomer as a raw material for a polymer compound, a polymerization initiator, and if necessary other material such as a polymerization inhibitor is prepared, which is injected into the package member 40. Finally, the opening of the package member 40 is hermetically sealed by thermal fusion bonding under the vacuum atmosphere. After that, the monomer is polymerized by applying heat to obtain a polymer compound. Thereby, the gel electrolyte layer 36 is formed. Consequently, the secondary battery shown in FIG. 3 and FIG. 4 is fabricated.

The secondary battery works as the first secondary battery does, and provides effects similar to those of the first secondary battery.

### Third Secondary Battery

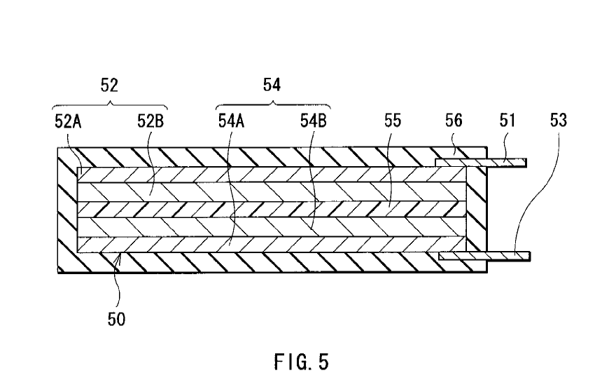

FIG. 5 shows a cross sectional structure of a third secondary battery. The secondary battery is a lithium ion secondary battery similar to the first secondary battery. In the secondary battery, a falt electrode body 50 in which a cathode 52 attached with a cathode lead 51 and an anode 54 attached with an anode lead 53 are oppositely arranged with an electrolyte layer 55 in between is contained in a film package member 56. The structure of the package member 56 is similar to that of the package member 40 in the foregoing second secondary battery.

The cathode 52 has a structure in which a cathode current collector 52A is provided with a cathode active material layer 52B. The anode 54 has a structure in which an anode current collector 54A is provided with an anode active material layer 54B. Arrangement is made so that the anode active material layer 54B side is opposed to the cathode active material layer 52B. Structures of the cathode current collector 52A, the cathode active material layer 52B, the anode current collector 54A, and the anode active material layer 54B are respectively similar to those of the cathode current collector 21A, the cathode active material layer 21B, the anode current collector 22A, and the anode active material layer 22B in the first secondary battery described above.

The electrolyte layer 55 is made of, for example, a solid electrolyte. As a solid electrolyte, for example, either an inorganic solid electrolyte or a polymer solid electrolyte may be used as long as the solid electrolyte is a material having lithium ion conductivity. As an inorganic solid electrolyte, the electrolyte containing lithium nitride, lithium iodide or the like is cited. The polymer solid electrolyte is the electrolyte mainly including an electrolyte salt and a polymer compound dissolving the electrolyte salt. As the polymer compound of the polymer solid electrolyte, for example, an ether polymer compound such as polyethylene oxide and a cross-linked compound containing polyethylene oxide, an ester polymer compound such as polymethacrylate, an acrylate polymer compound or the like may be used singly, by mixing, or by copolymerization.

The polymer solid electrolyte may be formed by, for example, mixing a polymer compound, an electrolyte salt, and a mixed solvent, and then volatilizing the mixed solvent. Otherwise, the polymer solid electrolyte may be formed by dissolving an electrolyte salt, a monomer as a raw material for a polymer compound, a copolymerization initiator, and if necessary other material such as a polymerization inhibitor into a mixed solvent, volatilizing the mixed solvent, and then applying heat to polymerize the monomer to obtain the polymer compound.

The inorganic solid electrolyte is formed, for example, on the surface of the cathode 52 or the anode 54 by, for example, a vapor-phase deposition method such as sputtering method, vacuum evaporation method, laser ablation method, ion plating method, and CVD (Chemical Vapor Deposition) method; or a liquid-phase deposition method such as sol-gel method.

The secondary battery works as the first or the second secondary battery does, and provides effects similar to those of the first or the second secondary battery.

### EXAMPLES

Further, specific examples of the invention will be described in detail.

### Examples 1-1 to 1-7

First, anode active materials were formed. That is, as raw materials, tin powder, iron powder, cobalt powder, and carbon powder were prepared. The tin powder, the iron powder, and the cobalt powder were alloyed to obtain tin-iron-cobalt alloy powder, to which the carbon powder was added and the resultant was dry-blended. The ratios of the raw materials (raw material ratio: wt %) were changed as shown in Table 1. Specifically, the total ratio of iron and cobalt to the total of tin, iron, and cobalt (hereinafter referred to as (Fe+Co)/(Sn+Fe+Co) ratio) was set to the constant value of 32 wt %. The cobalt ratio to the total of iron and cobalt (hereinafter referred to as Co/(Fe+Co) ratio) was set to the constant value of 50 wt %. The raw material ratio of carbon was changed in the range from 12 wt % to 30 wt %. Subsequently, 20 g of the foregoing mixture together with about 400 g of corundum being 9 mm in diameter was set into a reaction vessel of a planetary ball mill of ITO Seisakusho Co., Ltd. Subsequently, after inside of the reaction vessel was substituted with argon (Ar) atmosphere, 10-minute operation at a rotational speed of 250 rpm and 10-minute break were repeated until the total operation time (reaction time) became 30 hours. Finally, the reaction vessel was cooled down to room temperature, and the synthesized anode active material powder was taken out, from which coarse powder was removed through a 280-mesh sieve.

TABLE 1
(Fe + Co)/(Sn + Fe + Co) = 32 wt %, Co/(Fe + Co) = 50 wt %

| | | | | | | | | | | Initial | |
|---|---|---|---|---|---|---|---|---|---|---|---|
| | Raw material ratio | | | | Analytical value | | | | | charge | Capacity |
| | (wt %) | | | | (wt %) | | | | Half- | capacity | retention |
| | Fe | Co | Sn | C | Fe | Co | Sn | C | width (deg) | (mAh/g) | ratio (%) |
| Example 1-1 | 14.1 | 14.1 | 59.8 | 12 | 14.2 | 14 | 59.6 | 11.9 | 1.03 | 545.5 | 42 |
| Example 1-2 | 13.6 | 13.6 | 57.8 | 15 | 13.7 | 13.5 | 57.6 | 14.9 | 1.12 | 578.2 | 50.4 |
| Example 1-3 | 13.1 | 13.1 | 55.8 | 18 | 13.2 | 13 | 55.6 | 17.8 | 1.66 | 621.3 | 56 |
| Example 1-4 | 12.6 | 12.6 | 53.7 | 21 | 12.7 | 12.5 | 53.5 | 20.8 | 1.79 | 632.7 | 58.1 |
| Example 1-5 | 12.2 | 12.2 | 51.7 | 24 | 12.3 | 12.1 | 51.5 | 23.8 | 1.81 | 629.5 | 59.5 |
| Example 1-6 | 11.7 | 11.7 | 49.6 | 27 | 11.8 | 11.6 | 49.4 | 26.7 | 1.84 | 608.6 | 58.8 |
| Example 1-7 | 11.2 | 11.2 | 47.6 | 30 | 11.3 | 11.2 | 47.4 | 29.7 | 1.88 | 586.4 | 57.4 |
| Comparative | 16 | 16 | 68 | 0 | 16.1 | 15.9 | 67.7 | 0 | 0.19 | 119.9 | 0 |
| example 1-1 | | | | | | | | | | | |
| Comparative | 15 | 15 | 63.9 | 6 | 15.1 | 14.9 | 63.6 | 5.9 | 0.38 | 469.1 | 0 |
| example 1-2 | | | | | | | | | | | |
| Comparative | 14.4 | 14.4 | 61.2 | 10 | 14.5 | 14.3 | 60.9 | 9.9 | 0.82 | 530.9 | 0 |
| example 1-3 | | | | | | | | | | | |
| Comparative | 10.9 | 10.9 | 46.2 | 32 | 11 | 10.8 | 46 | 31.7 | 1.93 | 567 | 0 |
| example 1-4 | | | | | | | | | | | |
| Comparative | 9.6 | 9.6 | 40.8 | 40 | 9.7 | 9.6 | 40.6 | 39.6 | 2.04 | 361.9 | 0 |
| example 1-5 | | | | | | | | | | | |

The composition of the obtained anode active material was analyzed. The carbon content was measured by a carbon-sulfur analyzer, and the tin content, the iron content, and the cobalt content were measured by ICP (Inductively Coupled Plasma) emission spectrometry. The analytical values (wt %) are shown in Table 1. All the raw material ratios and the analytical values shown in Table 1 are values obtained by half-adjusting the hundredth. The same will be applied to the following series of examples and comparative examples.

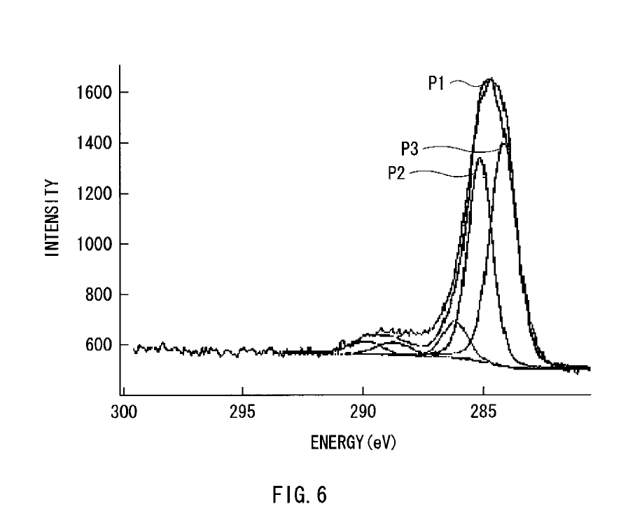

Further, for the obtained anode active material, X-ray diffraction was conducted. In the result, 2 diffraction peaks were observed in the range of 2θ=from 20 to 50 degrees. Of the foregoing, the half-width of the diffraction peak observed in the range of 2η=from 41 to 45 degrees is shown in Table 1. Further, the bonding state of the elements in the anode active material was measured by XPS. In the result, as shown in FIG. 6, Peak P1 was obtained. When Peak P1 was analyzed, Peak P2 of the surface contamination carbon was obtained, and Peak P3 of C1s in the anode active material was obtained on the energy side lower than that of Peak P2. For all Examples 1-1 to 1-7, Peak P3 was obtained in the region lower than 284.5 eV. That is, it was confirmed that the carbon in the anode active material was bonded to other element.

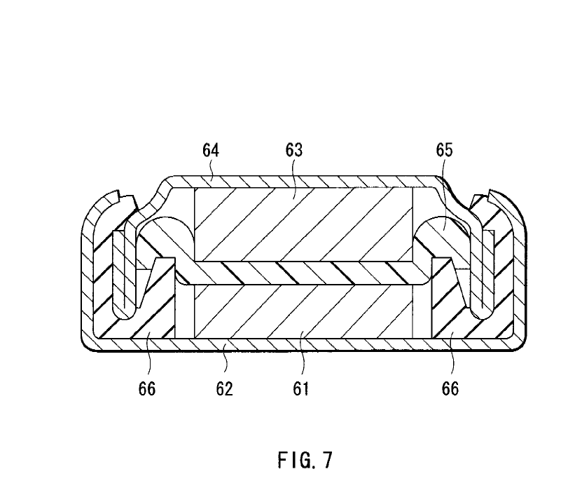

Next, a coin type secondary battery shown in FIG. 7 was fabricated by using the foregoing anode active material powder. In the secondary battery, a test electrode 61 using the anode active material was contained in a cathode can 62, and a counter electrode 63 was attached to an anode can 64. These components were layered with a separator 65 impregnated with an electrolytic solution in between, and then the resultant is caulked with a gasket 66. When the test electrode 61 was prepared, 70 parts by weight of the anode active material powder, 20 parts by weight of graphite as an electrical conductor and other anode active material, 1 part by weight of acetylene black as an electrical conductor, and 4 parts by weight of polyvinylidene fluoride as a binder were mixed. The mixture was dispersed in an appropriate solvent to obtain slurry. After that, a copper foil current collector was coated with the slurry, which was then dried. The resultant was punched out into a pellet being 15.2 mm in diameter. As the counter electrode 63, a metal lithium plate punched-out being 15.5 mm in diameter was used. Ethylene carbonate (EC), propylene carbonate (PC), and dimethyl carbonate (DMC) were mixed to obtain a mixed solvent, LiPF₆ as an electrolyte salt was dissolved in the mixed solvent, and the resultant was used as the electrolytic solution. The mixed solvent composition was EC:PC:DMC=30:10:60 at a weight ratio, and the concentration of the electrolyte salt was 1 mol/dm³.

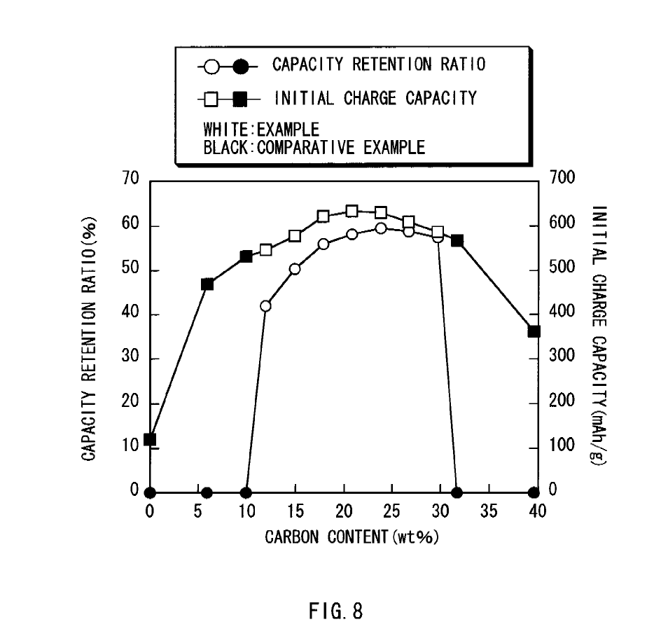

For the coin type secondary battery, the initial charge capacity (mAh/g) was examined. As the initial charge capacity, constant current charge was performed at the constant current of 1 mA until the battery voltage reached 0.2 mV. After that, constant voltage charge was performed at the constant voltage of 0.2 mV until the current reached 10 μA. Then, the charge capacity per unit weight resulting from subtracting the weight of the copper foil current collector and the binder from the weight of the test electrode 61 was obtained. “Charge” herein means lithium insertion reaction to the anode active material. The results are shown in Table 1 and FIG. 8.

Further, the cylindrical type secondary battery shown in FIG. 1 and FIG. 2 was fabricated by using the foregoing anode active material powder. That is, a cathode active material including a nickel oxide, Ketjen black as an electrical conductor, polyvinylidene fluoride as a binder were mixed at a weight ratio of nickel oxide:Ketjen black:polyvinylidene fluoride=94:3:3. The mixture was dispersed in N-methyl-2-pyrrolidone as a mixed solvent to obtain cathode mixture slurry. Subsequently, the both faces of the cathode current collector 21A made of a strip-shaped aluminum foil were uniformly coated with the cathode mixture slurry, which was dried. Then, the resultant was compression-molded by a rolling press machine to form the cathode active material layer 21B. Thereby, the cathode 21 was formed. After that, the cathode lead 25 made of aluminum was attached to an end of the cathode current collector 21A.

Further, the both faces of the anode current collector 22A made of a strip-shaped copper foil were uniformly coated with anode mixture slurry containing the foregoing anode active material, which was dried. Then, the resultant was compression-molded by a rolling press machine to form the anode active material layer 22B. Thereby, the anode 22 was formed. After that, the anode lead 26 made of nickel was attached to an end of the anode current collector 22A.

Subsequently, the separator 23 was prepared. The anode 22, the separator 23, the cathode 21, and the separator 23 were layered in this order. The resultant laminated body was spirally wound several times, and thereby the spirally wound electrode body 20 was formed. Subsequently, the spirally wound electrode body 20 was sandwiched between the pair of insulating plates 12 and 13. The anode lead 26 was welded to the battery can 11, and the cathode lead 25 was welded to the safety valve mechanism 15. After that, the spirally wound electrode body 20 was contained in the battery can 11 made of iron plated by nickel. Finally, the foregoing electrolytic solution was injected into the battery can 11 by pressure reduction method, and thereby the cylindrical type secondary battery was fabricated.

For the cylindrical type secondary battery, the cycle characteristics were examined. In this case, first, after constant current charge at the constant current of 0.5 A was performed until the battery voltage reached 4.2 V, constant voltage charge at the constant voltage of 4.2 V was performed until the current reached 10 mA. Subsequently, constant current discharge at constant current of 0.25 A was performed until the battery voltage reached 2.6 V, and thereby the first cycle of charge and discharge was performed. On and after the second cycle, after constant current charge at the constant current of 1.4 A was performed until the battery voltage reached 4.2 V, constant voltage charge at the constant voltage of 4.2 V was performed until the current reached 10 mA. Subsequently, constant current discharge at constant current of 1.0 A was performed until the battery voltage reached 2.6 V. After that, to examine the cycle characteristics, the ratio of the discharge capacity at the 300th cycle to the discharge capacity at the second cycle, that is, the capacity retention ratio (%)=(discharge capacity at the 300th cycle/discharge capacity at the second cycle)×100 was obtained. The results are shown in Table 1 and FIG. 8.

As Comparative example 1-1 relative to Examples 1-1 to 1-7, an anode active material and a secondary battery were formed in the same manner as that of Examples 1-1 to 1-7, except that the carbon powder was not used as a raw material. As Comparative examples 1-2 to 1-5, anode active materials and secondary batteries were formed in the same manner as that of Examples 1-1 to 1-7, except that the raw material ratio of carbon was changed as shown in Table 1.

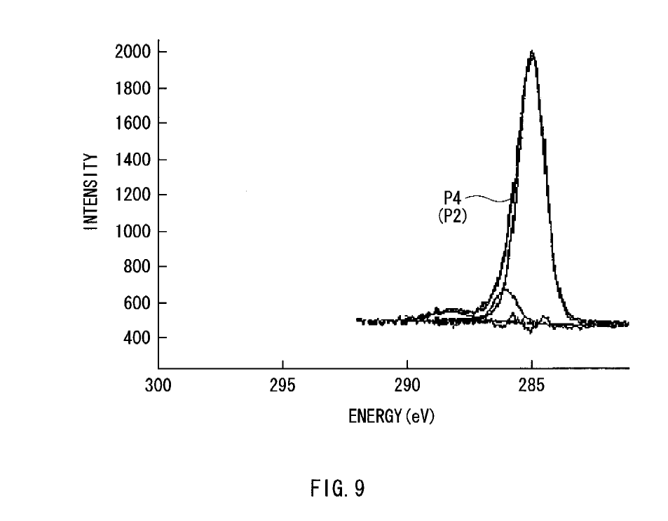

For the anode active materials of Comparative examples 1-1 to 1-5, the half-width of the diffraction peak observed in the range of 2θ=from 41 to 45 degrees was measured. The results are shown in Table 1. Further, when the bonding state of the elements was measured by XPS, in Comparative examples 1-2 to 1-5, Peak P1 shown in FIG. 6 was obtained. When Peak P1 was analyzed, as in Examples 1-1 to 1-7, Peak P2 of the surface contamination carbon and Peak P3 of C1s in the anode active material were obtained, and for all comparative examples, Peak P3 was obtained in the region lower than 284.5 eV. That is, it was confirmed that at least part of carbon contained in the anode active material was bonded to other element. Meanwhile, in Comparative example 1-1, as shown in FIG. 9, peak P4 was obtained. When Peak P4 was analyzed, only Peak P2 of the surface contamination carbon was obtained.

Further, for the secondary batteries of Comparative examples 1-1 to 1-5, the initial charge capacity and the cycle characteristics were examined in the same manner as that of Examples 1-1 to 1-7. The results are shown in Table 1 and FIG. 8.

As evidenced by Table 1 and FIG. 8, in Examples 1-1 to 1-7 in which the carbon content in the anode active material was in the range from 11.9 wt % to 29.7 wt %, the capacity retention ratio thereof was more significantly improved than that of Comparative examples 1-1 to 1-5 in which the carbon content was out of the range, and the initial charge capacity was also improved. In this case, the capacity retention ratio and the initial charge capacity were more improved when the carbon content was 14.9 wt % or more, and more particularly 17.8 wt % or more. In particular, in all Examples 1-1 to 1-7, the half-width was 1.00 degree or more.

That is, it was found that if the carbon content was from 11.9 wt % to 29.7 wt %, the capacity and the cycle characteristics could be improved. It was also found that the carbon content was preferably in the range from 14.9 wt % to 29.7 wt %, and was more preferably in the range from 17.8 wt % to 29.7 wt %.

### Examples 2-1 to 2-8

Anode active materials and secondary batteries were formed in the same manner as that of Examples 1-1 to 1-7, except that the raw material ratios of tin, iron, cobalt, and carbon were changed as shown in Table 2. Specifically, the raw material ratio of carbon was set to the constant value of 18 wt %, the Co/(Fe+Co) ratio was set to the constant value of 50 wt %, and the (Fe+Co)/(Sn+Fe+Co) ratio was changed in the range from 26 wt % to 48 wt %.

TABLE 2
Co/(Fe + Co) = 50 wt %

| | | | | | | | | | | | Initial | |
|---|---|---|---|---|---|---|---|---|---|---|---|---|
| | Raw material ratio | | | | Analytical value | | | | | | charge | Capacity |
| | (wt %) | | | | (wt %) | | | | (Fe + Co)/ | Half- | capacity | retention |
| | Fe | Co | Sn | C | Fe | Co | Sn | C | (Sn + Fe + Co) (wt %) | width (deg) | (mAh/g) | ratio (%) |
| Example 2-1 | 10.7 | 10.7 | 60.7 | 18 | 11 | 10.6 | 60.1 | 17.8 | 26.4 | 1.05 | 619.6 | 49 |
| Example 2-2 | 11.9 | 11.9 | 58.2 | 18 | 12.1 | 11.8 | 58 | 17.8 | 29.2 | 1.34 | 628.5 | 55 |
| Example 1-3 | 13.1 | 13.1 | 55.8 | 18 | 13.2 | 13 | 55.6 | 17.8 | 32 | 1.66 | 621.3 | 56 |
| Example 2-3 | 13.9 | 13.9 | 54.1 | 18 | 14.2 | 13.8 | 53.8 | 17.8 | 34.3 | 1.78 | 602.4 | 58 |
| Example 2-4 | 14.8 | 14.8 | 52.5 | 18 | 15 | 14.7 | 52.3 | 17.8 | 36.2 | 1.91 | 575 | 58 |
| Example 2-5 | 16 | 16 | 50 | 18 | 16.2 | 15.9 | 49.8 | 17.8 | 39.2 | 2.04 | 552.4 | 59 |
| Example 2-6 | 17.2 | 17.2 | 47.6 | 18 | 17.5 | 17.1 | 47.3 | 17.8 | 42.3 | 2.23 | 521.3 | 61 |
| Example 2-7 | 18.5 | 18.5 | 45.1 | 18 | 18.7 | 18.4 | 44.9 | 17.8 | 45.2 | 2.69 | 483.8 | 63 |
| Example 2-8 | 19.7 | 19.7 | 42.6 | 18 | 20.1 | 19.6 | 42.1 | 17.8 | 48.5 | 3.01 | 453.6 | 66 |
| Comparative | 7.8 | 7.8 | 66.4 | 18 | 8 | 7.7 | 66.2 | 17.8 | 19.1 | 0.23 | 549.3 | 0 |
| example 2-1 | | | | | | | | | | | | |
| Comparative | 8.6 | 8.6 | 64.8 | 18 | 8.9 | 8.5 | 64.5 | 17.8 | 21.3 | 0.31 | 570.7 | 0 |
| example 2-2 | | | | | | | | | | | | |
| Comparative | 10.3 | 10.3 | 61.5 | 18 | 10.5 | 10.2 | 61.3 | 17.8 | 25.2 | 0.79 | 617.3 | 15 |
| example 2-3 | | | | | | | | | | | | |
| Comparative | 20.1 | 20.1 | 41.8 | 18 | 20.3 | 20 | 41.6 | 17.8 | 49.2 | 3.21 | 429.9 | 68 |
| example 2-4 | | | | | | | | | | | | |
| Comparative | 20.5 | 20.5 | 41 | 18 | 20.9 | 20.4 | 40.7 | 17.8 | 50.4 | 3.54 | 401.5 | 69 |
| example 2-5 | | | | | | | | | | | | |

As Comparative examples 2-1 to 2-5 relative to Examples 2-1 to 2-8, anode active materials and secondary batteries were formed in the same manner as that of Examples 2-1 to 2-8, except that the (Fe+Co)/(Sn+Fe+Co) ratio was changed as shown in Table 2.

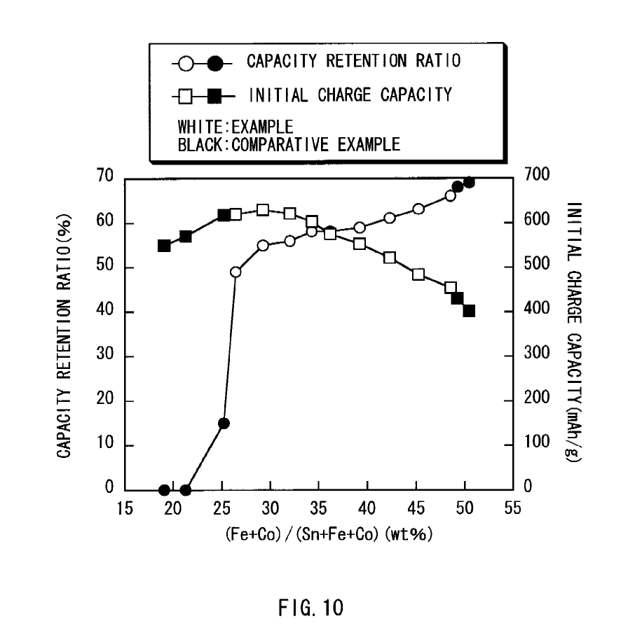

For the anode active materials of Examples 2-1 to 2-8 and Comparative examples 2-1 to 2-5, the composition thereof was analyzed in the same manner as that of Examples 1-1 to 1-7. The results are shown in Table 2. Further, X-ray diffraction was performed for the anode active materials, and the half-width of the diffraction peak observed in the range of 2θ=from 41 to 45 degrees was measured. The results are also shown in Table 2. Further, when the peak obtained by measuring the anode active materials by XPS was analyzed, Peak P2 of the surface contamination carbon and Peak P3 of C1s in the anode active material were obtained, and for all examples, Peak P3 was obtained in the region lower than 284.5 eV. That is, it was confirmed that at least part of carbon contained in the anode active material was bonded to other element. In addition, for the secondary batteries, the initial charge capacity and the cycle characteristics were examined in the same manner as that of Examples 1-1 to 1-7. The results are shown in Table 2 and FIG. 10.

As evidenced by Table 2 and FIG. 10, in Examples 2-1 to 2-8 in which the (Fe+Co)/(Sn+Fe+Co) ratio was in the range from 26.4 wt % to 48.5 wt %, the capacity retention ratio was more outstandingly improved than that of Comparative examples 2-1 to 2-3 in which the (Fe+Co)/(Sn+Fe+Co) ratio was under 26.4 wt %, and the initial charge capacity was more improved than that of Comparative examples 2-4 and 2-5 in which the (Fe+Co)/(Sn+Fe+Co) ratio was over 48.5 wt %. In this case, if the (Fe+Co)/(Sn+Fe+Co) ratio was in the range of 29.2 wt % or more, the capacity retention ratio was higher. In particular, in all Examples 2-1 to 2-8, the half-width was 1.00 degree or more.

That is, it was found that if the (Fe+Co)/(Sn+Fe+Co) ratio was in the range from 26.4 wt % to 48.5 wt %, the capacity and the cycle characteristics could be improved. It was also found that the (Fe+Co)/(Sn+Fe+Co) ratio was more preferably in the range from 29.2 wt % to 48.5 wt %.

### Examples 3-1 to 3-7

Anode active materials and secondary batteries were formed in the same manner as that of Examples 1-1to 1-7, except that the raw material ratios of tin, iron, cobalt, and carbon were changed as shown in Table 3. Specifically, the raw material ratio of carbon was set to the constant value of 18 wt%, the (Fe+Co)/(Sn+Fe+Co) ratio was set to the constant value of 32 wt %, and the Co/(Fe+Co) ratio was charnged in the range from 10 wt % to 80 wt %.

TABLE 3
(Fe + Co)/(Sn + Fe + Co) = 32 wt %

| | | | | | | | | | | | Initial | |
|---|---|---|---|---|---|---|---|---|---|---|---|---|
| | Raw material ratio | | | | Analytical value | | | | | | charge | Capacity |
| | (wt %) | | | | (wt %) | | | | Co/ | Half- | capacity | retention |
| | Fe | Co | Sn | C | Fe | Co | Sn | C | (Fe + Co) (wt %) | width (deg) | (mAh/g) | ratio (%) |
| Example 3-1 | 23.6 | 2.6 | 55.8 | 18 | 23.7 | 2.6 | 55.6 | 17.8 | 9.9 | 1.07 | 632.3 | 32 |
| Example 3-2 | 21 | 5.2 | 55.8 | 18 | 21.2 | 5.1 | 55.6 | 17.8 | 19.5 | 1.28 | 629.1 | 37 |
| Example 3-3 | 18.4 | 7.9 | 55.8 | 18 | 18.6 | 7.8 | 55.6 | 17.8 | 29.5 | 1.43 | 626.7 | 47 |
| Example 3-4 | 15.7 | 10.5 | 55.8 | 18 | 15.9 | 10.4 | 55.6 | 17.8 | 39.5 | 1.58 | 624 | 51 |
| Example 1-3 | 13.1 | 13.1 | 55.8 | 18 | 13.2 | 13 | 55.6 | 17.8 | 49.6 | 1.66 | 621.3 | 56 |
| Example 3-5 | 10.5 | 15.7 | 55.8 | 18 | 10.6 | 15.5 | 55.6 | 17.8 | 59.5 | 2.13 | 618.9 | 58 |
| Example 3-6 | 7.9 | 18.4 | 55.8 | 18 | 8 | 18.2 | 55.6 | 17.8 | 69.5 | 3.09 | 616.8 | 60 |
| Example 3-7 | 5.2 | 21 | 55.8 | 18 | 5.3 | 20.8 | 55.6 | 17.8 | 79.5 | 4.36 | 613.5 | 61 |
| Comparative | 26.2 | 0 | 55.8 | 18 | 26.4 | 0 | 55.6 | 17.8 | 0 | 0.18 | 634 | 25 |
| example 3-1 | | | | | | | | | | | | |
| Comparative | 24.1 | 2.1 | 55.8 | 18 | 24.3 | 2 | 55.6 | 17.8 | 7.6 | 0.88 | 633.2 | 30 |
| example 3-2 | | | | | | | | | | | | |
| Comparative | 2.6 | 23.6 | 55.8 | 18 | 2.7 | 23.3 | 55.6 | 17.8 | 89.5 | 4.83 | 562.1 | 63 |
| example 3-3 | | | | | | | | | | | | |
| Comparative | 0 | 26.2 | 55.8 | 18 | 0.1 | 25.9 | 55.6 | 17.8 | 99.6 | 5.01 | 563.6 | 62 |
| example 3-4 | | | | | | | | | | | | |

As Comparative examples 3-1 to 3-4 relative to Examples 3-1 to 3-7, anode active materials and secondary batteries were formed in the same manner as that of Examples 3-1 to 3-7, except that the Co/(Fe+Co) ratio was changed as shown in Table 3.

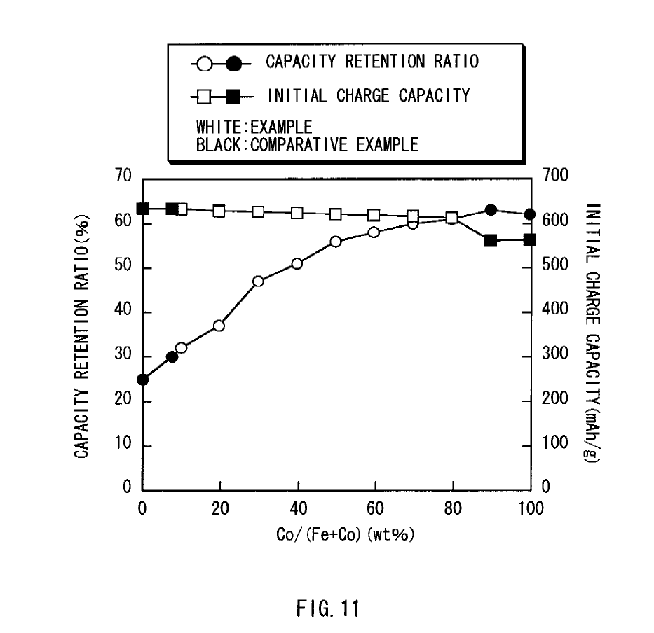

For the anode active materials of Examples 3-1 to 3-7 and Comparative examples 3-1 to 3-4, the composition thereof was analyzed in the same manner as that of Examples 1-1 to 1-7. The results are shown in Table 3. Further, X-ray diffraction was performed for the anode active materials, and the half-width of the diffraction peak observed in the range of 2θ=from 41 to 45 degrees was measured. The results are also shown in Table 3. Further, when the peak obtained by measuring the anode active materials by XPS was analyzed, as in Examples 1-1 to 1-7, Peak P2 of the surface contamination carbon and Peak P3 of C1s in the anode active material were obtained, and for all examples, Peak P3 was obtained in the region lower than 284.5 eV. That is, it was confirmed that at least part of carbon contained in the anode active material was bonded to other element. In addition, for the secondary batteries, the initial charge capacity and the cycle characteristics were examined in the same manner as that of Examples 1-1 to 1-7. The results are shown in Table 3 and FIG. 11.

As evidenced by Table 3 and FIG. 11, in Examples 3-1 to 3-7 in which the Co/(Fe+Co) ratio was in the range from 9.9 wt % to 79.5 wt %, the capacity retention ratio was more improved than that of Comparative examples 3-1 and 3-2 in which the Co/(Fe+Co) ratio was under 9.9 wt %, and the initial charge capacity was more improved than that of Comparative examples 3-3 and 3-4 in which the Co/(Fe+Co) ratio was over 79.5 wt %. In this case, the capacity retention ratio was still higher if the (Fe+Co)/(Sn+Fe+Co) ratio was 29.5 wt % or more. In particular, in all Examples 3-1 to 3-7, the half-width was 1.00 degree or more.

That is, it was found that if the (Fe+Co)/(Sn+Fe+Co) ratio was in the range from 9.9 wt % to 79.5 wt %, the capacity and the cycle characteristics could be improved. It was also found that the (Fe+Co)/(Sn+Fe+Co) ratio was more preferably in the range from 29.5 wt % to 79.5 wt %.

### Examples 4-1 to 4-17

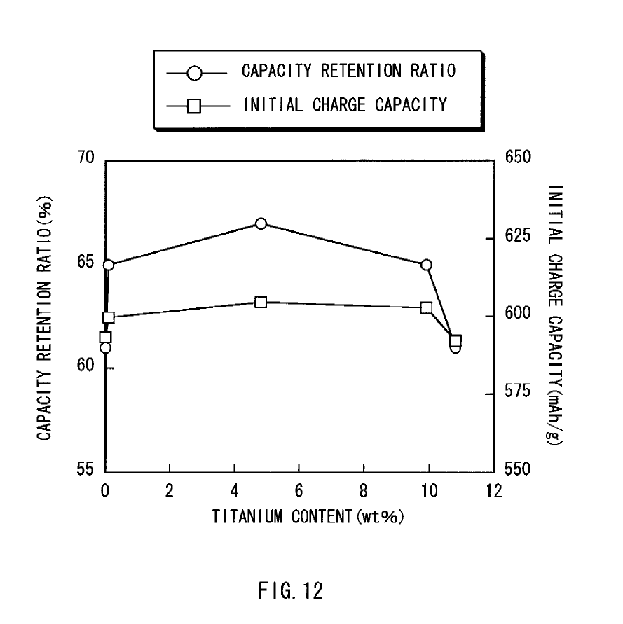

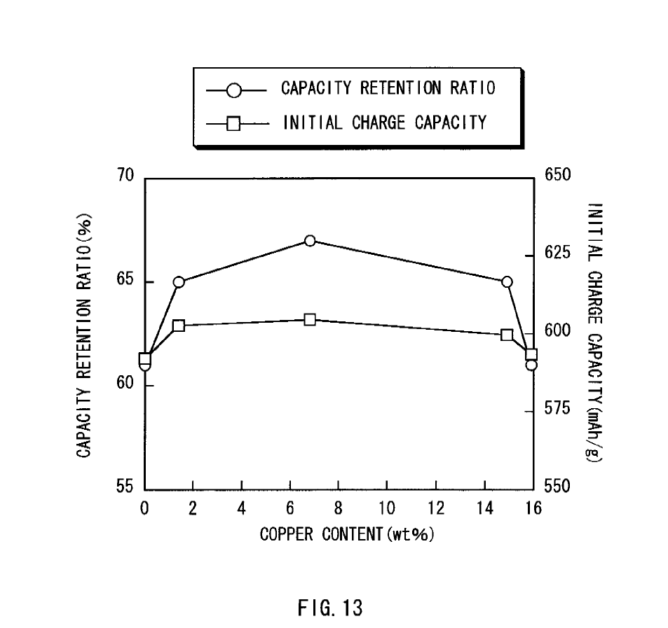

Anode active materials and secondary batteries were formed in the same manner as that of Examples 1-1 to 1-7, except that tin powder, iron powder, cobalt powder, and carbon powder; aluminum powder, titanium powder, vanadium powder, chromium powder, niobium powder, or tantalum powder; and nickel powder, copper powder, indium powder, zinc powder, or gallium powder were used as a raw material, and the raw material ratios of tin, iron, cobalt, carbon, aluminum or the like, and nickel or the like were changed as shown in Table 4. Specifically, the raw material ratio of carbon was set to the constant value of 18 wt %, the (Fe+Co)/(Sn+Fe+Co) ratio was set to the constant value of 32 wt %, the Co/(Fe+Co) ratio was set to the constant value of 50 wt %, and the raw material ratios of aluminum or the like and nickel or the like were changed as appropriate. When the anode active material was formed, the tin powder, the iron powder, and the cobalt powder were alloyed to obtain tin-iron-cobalt alloy powder. After that, the carbon powder, the aluminum powder or the like, and the nickel powder or the like were mixed therewith. For the anode active materials of Examples 4-1 to 4-17, the composition thereof was analyzed in the same manner as that of Examples 1-1 to 1-7. The contents of aluminum or the like and the nickel or the like were measured by ICP emission spectrometry. The results are shown in Table 5. Further, X-ray diffraction was performed for the anode active materials, and the half-width of the diffraction peak observed in the range of 2θ=from 41 to 45 degrees was measured. The results are shown in Table 6. Further, when the peak obtained by measuring the anode active materials by XPS was analyzed, as in Examples 1-1 to 1-7, Peak P2 of the surface contamination carbon and Peak P3 of C1s in the anode active material were obtained, and for all examples, Peak P3 was obtained in the region lower than 284.5 eV. That is, it was confirmed that at least part of carbon contained in the anode active material was bonded to other element. In addition, for the secondary batteries, the initial charge capacity and the cycle characteristics were examined in the same manner as that of Examples 1-1 to 1-7. The results are shown in Table 6, FIG. 12, and FIG. 13.

TABLE 4
(Fe + Co)/(Sn + Fe + Co) = 32 wt %, Co/(Fe + Co) = 50 wt %

| | Raw material ratio | | | | | | | | | | | | | | |
|---|---|---|---|---|---|---|---|---|---|---|---|---|---|---|---|
| | (wt %) | | | | | | | | | | | | | | |
| | Fe | Co | Sn | C | Al | Ti | V | Cr | Nb | Ta | Ni | Cu | In | Zn | Ga |
| Example 1-3 | 13.1 | 13.1 | 55.8 | 18 | — | — | — | — | — | — | — | — | — | — | — |
| Example 4-1 | 10.7 | 10.7 | 45.5 | 18 | 0.1 | — | — | — | — | — | 15 | — | — | — | — |
| Example 4-2 | 11.2 | 11.2 | 47.6 | 18 | 5 | — | — | — | — | — | — | 7 | — | — | — |
| Example 4-3 | 11.4 | 11.4 | 48.6 | 18 | 10 | — | — | — | — | — | — | — | 0.5 | — | — |
| Example 4-4 | 10.6 | 10.6 | 44.9 | 18 | — | 0 | — | — | — | — | — | 16 | — | — | — |
| Example 4-5 | 10.7 | 10.7 | 45.5 | 18 | — | 0.1 | — | — | — | — | — | 15 | — | — | — |
| Example 4-6 | 11.2 | 11.2 | 47.6 | 18 | — | 5 | — | — | — | — | — | 7 | — | — | — |
| Example 4-7 | 11.3 | 11.3 | 47.9 | 18 | — | 10 | — | — | — | — | — | 0.5 | — | — | — |
| Example 4-8 | 11.4 | 11.4 | 48.3 | 18 | — | 11 | — | — | — | — | — | 0 | — | — | — |
| Example 4-9 | 11.2 | 11.2 | 47.6 | 18 | — | 5 | — | — | — | — | — | — | — | 7 | — |
| Example 4-10 | 11.4 | 11.4 | 48.6 | 18 | — | 10 | — | — | — | — | — | — | — | — | 0.5 |
| Example 4-11 | 12 | 12 | 50.9 | 18 | — | — | 0.1 | — | — | — | — | 7 | — | — | — |
| Example 4-12 | 11.4 | 11.4 | 48.3 | 18 | — | — | 10 | — | — | — | — | — | — | 1 | — |
| Example 4-13 | 11.5 | 11.5 | 49 | 18 | — | — | — | 5 | — | — | 5 | — | — | — | — |
| Example 4-14 | 11.5 | 11.5 | 49 | 18 | — | — | — | — | 3 | — | — | — | — | 7 | — |
| Example 4-15 | 11.5 | 11.5 | 49 | 18 | — | — | — | — | 5 | — | — | — | 5 | — | — |
| Example 4-16 | 11.5 | 11.5 | 49 | 18 | — | — | — | — | — | 3 | — | 7 | — | — | — |
| Example 4-17 | 11.5 | 11.5 | 49 | 18 | — | — | — | — | — | 5 | — | — | — | — | 5 |

TABLE 5
(Fe + Co)/(Sn + Fe + Co) = 32 wt %, Co/(Fe + Co) = 50 wt %

| | Analytical value | | | | | | | | | | | | | | |
|---|---|---|---|---|---|---|---|---|---|---|---|---|---|---|---|
| | (wt %) | | | | | | | | | | | | | | |
| | Fe | Co | Sn | C | Al | Ti | V | Cr | Nb | Ta | Ni | Cu | In | Zn | Ga |
| Example 1-3 | 13.2 | 13 | 55.6 | 17.8 | — | — | — | — | — | — | — | — | — | — | — |
| Example 4-1 | 10.9 | 10.6 | 45.3 | 17.8 | 0.1 | — | — | — | — | — | 14.9 | — | — | — | — |
| Example 4-2 | 11.4 | 11.1 | 47.4 | 17.8 | 4.8 | — | — | — | — | — | — | 6.8 | — | — | — |
| Example 4-3 | 11.6 | 11.3 | 48.4 | 17.8 | 9.9 | — | — | — | — | — | — | — | 0.5 | — | — |
| Example 4-4 | 10.8 | 10.5 | 44.7 | 17.8 | — | 0 | — | — | — | — | — | 15.9 | — | — | — |
| Example 4-5 | 10.9 | 10.6 | 45.3 | 17.8 | — | 0.1 | — | — | — | — | — | 14.9 | — | — | — |
| Example 4-6 | 11.4 | 11.1 | 47.4 | 17.8 | — | 4.8 | — | — | — | — | — | 6.8 | — | — | — |
| Example 4-7 | 11.5 | 11.2 | 47.7 | 17.8 | — | 9.9 | — | — | — | — | — | 0.5 | — | — | — |
| Example 4-8 | 11.6 | 11.3 | 48.1 | 17.8 | — | 10.8 | — | — | — | — | — | 0 | — | — | — |
| Example 4-9 | 11.4 | 11.1 | 47.4 | 17.8 | — | 4.8 | — | — | — | — | — | — | — | 6.8 | — |
| Example 4-10 | 11.6 | 11.3 | 48.4 | 17.8 | — | 9.9 | — | — | — | — | — | — | — | — | 0.5 |
| Example 4-11 | 12.2 | 11.9 | 50.7 | 17.8 | — | — | 0.1 | — | — | — | — | 6.8 | — | — | — |
| Example 4-12 | 11.6 | 11.3 | 48.1 | 17.8 | — | — | 9.9 | — | — | — | — | — | — | 1 | — |
| Example 4-13 | 11.7 | 11.4 | 48.8 | 17.8 | — | — | — | 4.8 | — | — | 4.8 | — | — | — | — |
| Example 4-14 | 11.7 | 11.4 | 48.8 | 17.8 | — | — | — | — | 2.9 | — | — | — | — | 6.8 | — |
| Example 4-15 | 11.7 | 11.4 | 48.8 | 17.8 | — | — | — | — | 4.8 | — | — | — | 4.8 | — | — |
| Example 4-16 | 11.7 | 11.4 | 48.8 | 17.8 | — | — | — | — | — | 2.9 | — | 6.8 | — | — | — |
| Example 4-17 | 11.7 | 11.4 | 48.8 | 17.8 | — | — | — | — | — | 4.8 | — | — | — | — | 4.8 |

TABLE 6
(Fe + Co)/(Sn + Fe + Co) = 32 wt %, Co/(Fe + Co) = 50 wt %

| | | Initial charge | Capacity retention |
|---|---|---|---|
| | Half-width | capacity | ratio |
| | (deg) | (mAh/g) | (%) |
| Example 1-3 | 1.66 | 621.3 | 56 |
| Example 4-1 | 1.70 | 598.3 | 65 |
| Example 4-2 | 1.69 | 603 | 62 |
| Example 4-3 | 1.69 | 605.3 | 61 |
| Example 4-4 | 1.72 | 593.4 | 61 |
| Example 4-5 | 1.70 | 599.7 | 65 |
| Example 4-6 | 1.69 | 604.6 | 67 |
| Example 4-7 | 1.69 | 602.8 | 65 |
| Example 4-8 | 1.73 | 592.1 | 61 |
| Example 4-9 | 1.69 | 604.2 | 62 |
| Example 4-10 | 1.68 | 606.8 | 61 |
| Example 4-11 | 1.68 | 610.5 | 57 |
| Example 4-12 | 1.69 | 604.6 | 61 |
| Example 4-13 | 1.68 | 606.1 | 60 |
| Example 4-14 | 1.67 | 612.3 | 60 |
| Example 4-15 | 1.68 | 609.5 | 60 |
| Example 4-16 | 1.71 | 610.3 | 60 |
| Example 4-17 | 1.72 | 604 | 56 |

As evidenced by Table 4 to Table 6, in Examples 4-1 to 4-7 in which only aluminum or the like was contained, or only nickel or the like was contained, or both aluminum or the like and nickel or the like were contained, compared to Example 1-3 in which aluminum or the like and nickel or the like were not contained, while almost equal initial charge capacity was retained, the capacity retention ratio was improved equal to or more than that on Example 1-3. In this case, as evidenced by Table 4 to Table 6 and FIG. 12 and FIG. 13, focusing attention on the titanium content as a representative of aluminum or the like and on the copper content as a representative of nickel or the like, the capacity retention ratio in the case that both titanium and copper were contained was higher than that in the case that only one of titanium and copper was contained. Further, in the case that both titanium and copper were contained, if the titanium content was in the range from 0.1 wt % to 9.9 wt % and the copper content was in the range from 0.5 wt % to 14.9 wt %, the capacity retention ratio was higher. In particular, in all Examples 4-1 to 4-17, the half-width was 1.00 degree or more.

That is, it was found that if the anode active material contained at least one selected from the group consisting of aluminum, titanium, vanadium, chromium, niobium, and tantalum; or in the case where the anode active material contained at least one selected from the group consisting of nickel, copper, zinc, gallium, and indium; or in the case where the anode active material contained the both thereof, the cycle characteristics could be more improved. Further, it was found that the case that the anode active material contained the both thereof was more preferable. In this case, it was found that it was more preferable that the content of aluminum or the like was in the range from 0.1 wt % to 9.9 wt % and the content of nickel or the like was in the range from 0.5 wt % to 14.9 wt %.

### Examples 5-1 to 5-9

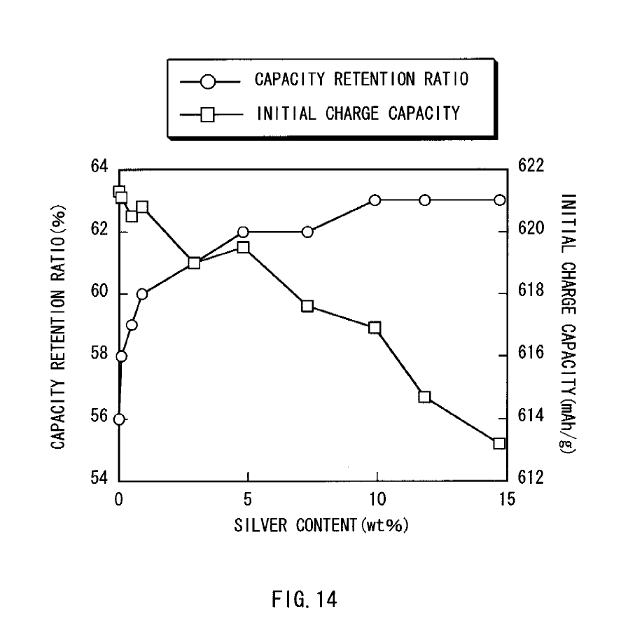

Anode active materials and secondary batteries were formed in the same manner as that of Examples 1-1 to 1-7, except that tin powder, iron powder, cobalt powder, and carbon powder; and silver powder were prepared as a raw material, and the raw material ratios were changed as shown in Table 7. Specifically, the raw material ratio of carbon was set to the constant value of 18 wt %, the (Fe+Co)/(Sn+Fe+Co) ratio was set to the constant value of 32 wt %, the Co/(Fe+Co) ratio was set to the constant value of 50 wt %, and the raw material ratio of silver was changed in the range from 0.1 wt % to 15 wt %. When the anode active material was formed, after the tin powder, the iron powder, and the cobalt powder were alloyed to obtain tin-iron-cobalt alloy powder, the carbon powder and the silver powder were mixed therewith. For the anode active materials of Examples 5-1 to 5-9, the composition thereof was analyzed in the same manner as that of Examples 1-1 to 1-7. The silver content was measured by ICP emission spectrometry. The results are shown in Table 7. Further, X-ray diffraction was performed for the anode active materials, and the half-width of the diffraction peak observed in the range of 2θ=from 41 to 45 degrees was measured. The results are also shown in Table 7. Further, when the peak obtained by measuring the anode active materials by XPS was analyzed, as in Examples 1-1 to 1-7, Peak P2 of the surface contamination carbon and Peak P3 of C1s in the anode active material were obtained, and for all examples, Peak P3 was obtained in the region lower than 284.5 eV. That is, it was confirmed that at least part of carbon contained in the anode active material was bonded to other element. In addition, further, for the secondary batteries, the initial charge capacity and the cycle characteristics were examined in the same manner as that of Examples 1-1 to 1-7. The results are shown in Table 7 and FIG. 14.

TABLE 7
(Fe + Co)/(Sn + Fe + Co) = 32 wt %, Co/(Fe + Co) = 50 wt %

| | | | | | | | | | | | | Initial | |
|---|---|---|---|---|---|---|---|---|---|---|---|---|---|
| | Raw material ratio | | | | | Analytical value | | | | | | charge | Capacity |
| | (wt %) | | | | | (wt %) | | | | | Half- | capacity | retention |
| | Fe | Co | Sn | C | Ag | Fe | Co | Sn | C | Ag | width (deg) | (mAh/g) | ratio (%) |
| Example 1-3 | 13.1 | 13.1 | 55.8 | 18 | 0 | 13.2 | 13 | 55.6 | 17.8 | 0 | 1.66 | 621.3 | 56 |
| Example 5-1 | 13.1 | 13.1 | 55.7 | 18 | 0.1 | 13.2 | 13 | 55.5 | 17.8 | 0.1 | 1.66 | 621.1 | 58 |
| Example 5-2 | 13 | 13 | 55.4 | 18 | 0.5 | 13.1 | 12.9 | 55.2 | 17.8 | 0.5 | 1.69 | 620.5 | 59 |
| Example 5-3 | 13 | 13 | 55.1 | 18 | 1 | 13.1 | 12.9 | 54.9 | 17.8 | 0.9 | 1.69 | 620.8 | 60 |
| Example 5-4 | 12.6 | 12.6 | 53.7 | 18 | 3 | 12.7 | 12.6 | 53.5 | 17.8 | 2.9 | 1.71 | 619 | 61 |
| Example 5-5 | 12.3 | 12.3 | 52.4 | 18 | 5 | 12.4 | 12.2 | 52.2 | 17.8 | 4.8 | 1.73 | 619.5 | 62 |
| Example 5-6 | 11.9 | 11.9 | 50.7 | 18 | 7.5 | 12 | 11.8 | 50.5 | 17.8 | 7.3 | 1.73 | 617.6 | 62 |
| Example 5-7 | 11.5 | 11.5 | 49 | 18 | 10 | 11.6 | 11.4 | 48.8 | 17.8 | 9.9 | 1.75 | 616.9 | 63 |
| Example 5-8 | 11.2 | 11.2 | 47.6 | 18 | 12 | 11.3 | 11.1 | 47.4 | 17.8 | 11.8 | 1.76 | 614.7 | 63 |
| Example 5-9 | 10.7 | 10.7 | 45.6 | 18 | 15 | 10.8 | 10.6 | 45.4 | 17.8 | 14.7 | 1.78 | 613.2 | 63 |

As evidenced by Table 7 in FIG. 14, in Examples 5-1 to 5-9 in which silver was contained, compared top Example 1-3 in which silver was not contained, while the almost equal initial charge capacity was retained, the capacity retention ratio was improved. In this case, in the case where the silver content was in the range from 0.1 wt % to 9.9 wt %, and more particularly in the range from 0.9 wt % to 9.9 wt %, the capacity retention ratio was higher. In particular, in all Examples 5-1 to 5-9, the half-width was 1.00 degree or more.

That is, it was found that in the case where the anode active material contained silver, the cycle characteristics could be more improved. Further, it was found that the silver content was preferably in the range from 0.1 wt % to 9.9 wt %, and more preferably in the range from 0.9 wt % to 9.9 wt %,

### Examples 6-1 to 6-10

Anode active materials and secondary batteries were formed in the same manner as that of Examples 1-1 to 1-7, except that tin powder, iron powder, cobalt powder, and carbon powder; silver powder, aluminum powder, titanium powder, vanadium powder, chromium powder, niobium powder, or tantalum powder; and nickel powder, copper powder, indium powder, zinc powder, or gallium powder were used as a raw material, and the raw material ratios of tin, iron, cobalt, carbon, silver, aluminum or the like, and nickel or the like were changed as shown in Table 8. Specifically, the raw material ratio of carbon was set to the constant value of 18 wt %, the raw material ratio of silver was set to the constant value of 1 wt %, (Fe+Co)/(Sn+Fe+Co) ratio was set to the constant value of 32 wt %, the Co/(Fe+Co) ratio was set to the constant value of 50 wt %, and the raw material ratios of aluminum or the like and nickel or the like were changed as appropriate. When the anode active material was formed, after the tin powder, the iron powder, and the cobalt powder were alloyed to obtain tin-iron-cobalt alloy powder, the carbon powder, the silver powder, the aluminum powder or the like, and the nickel powder or the like were mixed therewith. For the anode active materials of Examples 6-1 to 6-10, the composition thereof was analyzed in the same manner as that of Examples 1-1 to 1-7. The results are shown in Table 9. Further, X-ray diffraction was performed for the anode active materials, and the half-width of the diffraction peak observed in the range of 2θ=from 41 to 45 degrees was measured. The results are shown in Table 10. Further, when the peak obtained by measuring the anode active materials by XPS was analyzed, as in Examples 1-1 ti 1-7, Peak P2 of the surface contamination carbon and Peak P3 of C1s in the anode active material were obtained, and for all examples, Peak P3 was obtained in the region lower than 284.5 eV. That is, it was confirmed that at least part of carbon contained in the anode active material was bonded to other element. In addition, for the secondary batteries, the initial charge capacity and the cycle characteristics were examined in the same manner as that of Examples 1-1 to 1-7. The results are shown in Table 10.

TABLE 8
(Fe + Co)/(Sn + Fe + Co) = 32 wt %, Co/(Fe + Co) = 50 wt %

| | Raw material ratio | | | | | | | | | | | | | | | |
|---|---|---|---|---|---|---|---|---|---|---|---|---|---|---|---|---|
| | (wt %) | | | | | | | | | | | | | | | |
| | Fe | Co | Sn | C | Ag | Al | Ti | V | Cr | Nb | Ta | Ni | Cu | In | Zn | Ga |
| Example 1-3 | 13.1 | 13.1 | 55.8 | 18 | — | — | — | — | — | — | — | — | — | — | — | — |
| Example 5-3 | 13 | 13 | 55.1 | 18 | 1 | — | — | — | — | — | — | — | — | — | — | — |
| Example 6-1 | 12.3 | 12.3 | 52.3 | 18 | 1 | 0.1 | — | — | — | — | — | 4 | — | — | — | — |
| Example 6-2 | 12.2 | 12.2 | 51.7 | 18 | 1 | 4 | — | — | — | — | — | — | — | 1 | — | — |
| Example 6-3 | 10.5 | 10.5 | 44.8 | 18 | 1 | — | 0.1 | — | — | — | — | — | 15 | — | — | — |
| Example 6-4 | 11.4 | 11.4 | 48.3 | 18 | 1 | — | 3 | — | — | — | — | — | 7 | — | — | — |
| Example 6-5 | 11.5 | 11.5 | 49 | 18 | 1 | — | 5 | — | — | — | — | — | — | — | 4 | — |
| Example 6-6 | 11.2 | 11.2 | 47.6 | 18 | 1 | — | 10 | — | — | — | — | — | — | — | 1 | — |
| Example 6-7 | 11.7 | 11.7 | 49.6 | 18 | 1 | — | — | 4 | — | — | — | — | — | — | — | 4 |
| Example 6-8 | 11.7 | 11.7 | 49.6 | 18 | 1 | — | — | — | 3 | — | — | 5 | — | — | — | — |
| Example 6-9 | 11.8 | 11.8 | 50.3 | 18 | 1 | — | — | — | — | 4 | — | — | 3 | — | — | — |
| Example 6-10 | 11.4 | 11.4 | 48.3 | 18 | 1 | — | — | — | — | — | 3 | — | — | — | 7 | — |

TABLE 9
(Fe + Co)/(Sn + Fe + Co) = 32 wt %, Co/(Fe + Co) = 50 wt %

| | Analytical value | | | | | | | | | | | | | | | |
|---|---|---|---|---|---|---|---|---|---|---|---|---|---|---|---|---|
| | (wt %) | | | | | | | | | | | | | | | |
| | Fe | Co | Sn | C | Ag | Al | Ti | V | Cr | Nb | Ta | Ni | Cu | In | Zn | Ga |
| Example 1-3 | 13.2 | 13 | 55.6 | 17.8 | — | — | — | — | — | — | — | — | — | — | — | — |
| Example 5-3 | 13.1 | 12.9 | 54.9 | 17.8 | 0.9 | — | — | — | — | — | — | — | — | — | — | — |
| Example 6-1 | 12.4 | 12.2 | 52.1 | 17.8 | 0.9 | 0.1 | — | — | — | — | — | 3.9 | — | — | — | — |
| Example 6-2 | 12.3 | 12.1 | 51.5 | 17.8 | 0.9 | 3.9 | — | — | — | — | — | — | — | 1 | — | — |
| Example 6-3 | 10.6 | 10.4 | 44.6 | 17.8 | 0.9 | — | 0.1 | — | — | — | — | — | 14.9 | — | — | — |
| Example 6-4 | 11.5 | 11.3 | 48.1 | 17.8 | 0.9 | — | 3 | — | — | — | — | — | 6.8 | — | — | — |
| Example 6-5 | 11.6 | 11.4 | 48.8 | 17.8 | 0.9 | — | 4.9 | — | — | — | — | — | — | — | 3.9 | — |
| Example 6-6 | 11.3 | 11.1 | 47.4 | 17.8 | 0.9 | — | 9.9 | — | — | — | — | — | — | — | 0.9 | — |
| Example 6-7 | 11.8 | 11.6 | 49.4 | 17.8 | 0.9 | — | — | 3.9 | — | — | — | — | — | — | — | 3.9 |
| Example 6-8 | 11.8 | 11.6 | 49.4 | 17.8 | 0.9 | — | — | — | 2.9 | — | — | 4.9 | — | — | — | — |
| Example 6-9 | 11.9 | 11.7 | 50.1 | 17.8 | 0.9 | — | — | — | — | 3.9 | — | — | 3 | — | — | — |
| Example 6-10 | 11.5 | 11.3 | 48.1 | 17.8 | 0.9 | — | — | — | — | — | 3 | — | — | — | 6.9 | — |

TABLE 10
(Fe + Co)/(Sn + Fe + Co) = 32 wt %, Co/(Fe + Co) = 50 wt %

| | | Initial charge | Capacity retention |
|---|---|---|---|
| | Half-width | capacity | ratio |
| | (deg) | (mAh/g) | (%) |
| Example 1-3 | 1.66 | 621.3 | 56 |
| Example 5-3 | 1.69 | 620.8 | 60 |
| Example 6-1 | 1.71 | 614.7 | 64 |
| Example 6-2 | 1.70 | 614.3 | 63 |
| Example 6-3 | 1.82 | 598.6 | 67 |
| Example 6-4 | 1.74 | 608.1 | 69 |
| Example 6-5 | 1.73 | 609.3 | 68 |
| Example 6-6 | 1.77 | 606.5 | 68 |
| Example 6-7 | 1.72 | 609.5 | 67 |
| Example 6-8 | 1.72 | 606.9 | 67 |
| Example 6-9 | 1.70 | 610.6 | 66 |
| Example 6-10 | 1.73 | 607.7 | 67 |

As evidence by Table 8 to Table 10, in Examples 6-1 to 6-10 in which silver, aluminum or the like, and nickel or the like were contained, compared to Example 1-3 in which silver, aluminum or the like, and nickel or the like were not contained or compared to Example 5-3 in which only silver was contained, while almost equal initial charge capacity was retained, the capacity retention ratio was improved. In particular, in all Examples 6-1 to 6-10, the half-width was 1.00 degree or more.

That is, it was found that in the case where the anode active material contained silver, at least one selected from the group consisting of aluminum, titanium, vanadium, chromium, niobium, and tantalum, and at least one selected from the group consisting of nickel, copper, zinc, gallium, and indium, the cycle characteristics could be more improved.

### Examples 7-1 to 7-5

Anode active materials and secondary batteries were formed in the same manner as that of Example 1-3, except that the crystallinity (half-width) was changed by changing the reaction time in synthesizing the anode active material as shown in Table 11. Specifically, the raw material ratio of carbon was set to the constant value of 18 wt %, the (Fe+Co)/(Sn+Fe+Co) ratio was set to the constant value of 32 wt %, the Co/(Fe+Co) ratio was set to the constant value of 50 wt %, and the half-width was 1.00 degree or more.

TABLE 11
(Fe + Co)/(Sn + Fe + Co) = 32 wt %, Co/(Fe + Co) = 50 wt %

| | | | | | | | | | | | Initial | |
|---|---|---|---|---|---|---|---|---|---|---|---|---|
| | Raw material ratio | | | | Analytical value | | | | | | charge | Capacity |
| | (wt %) | | | | (wt %) | | | | Reaction | Half- | capacity | retention |
| | Fe | Co | Sn | C | Fe | Co | Sn | C | time (h) | width (deg) | (mAh/g) | ratio (%) |
| Example 7-1 | 13.1 | 13.1 | 55.8 | 18 | 13.2 | 13 | 55.6 | 17.8 | 16 | 1.00 | 590.2 | 40 |
| Example 7-2 | | | | | | | | | 20 | 1.29 | 598.7 | 46 |
| Example 7-3 | | | | | | | | | 25 | 1.52 | 612.1 | 52 |
| Example 1-3 | | | | | | | | | 30 | 1.66 | 621.3 | 56 |
| Example 7-4 | | | | | | | | | 35 | 1.74 | 627.2 | 59 |
| Example 7-5 | | | | | | | | | 40 | 1.79 | 631.9 | 61 |
| Comparative | 13.1 | 13.1 | 55.8 | 18 | 13.2 | 13 | 55.6 | 17.8 | 10 | 0.43 | 515.7 | 9 |
| example 4-1 | | | | | | | | | | | | |
| Comparative | | | | | | | | | 15 | 0.97 | 562.1 | 30 |
| example 4-2 | | | | | | | | | | | | |

As Comparative examples 4-1 and 4-2 relative to Examples 7-1 to 7-5, anode active materials and secondary batteries were formed in the same manner as that of Example 1-3, except that the reaction time and the half-width were changed as shown in Table 11.

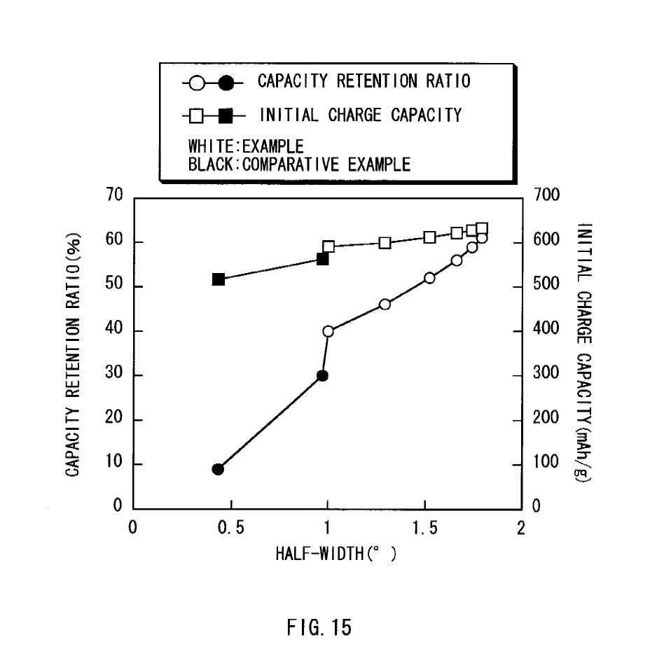

For the anode active materials of Examples 7-1 to 7-5 and Comparative examples 4-1 and 4-2, in the same manner as that of Examples 1-1 to 1-7, X-ray diffraction was performed for the anode active materials, and the half-width of the diffraction peak observed in the range of 2θ=from 41 to 45 degrees was measured. The results are shown in Table 11. Further, when the peak obtained by measuring the anode active materials by XPS was analyzed, as in Examples 1-1 to 1-7, Peak P2 of the surface contamination carbon and Peak P3 of C1s in the anode active material were obtained, and for all examples, Peak P3 was obtained in the region lower than 284.5 eV. That is, it was confirmed that at least part of carbon contained in the anode active material was bonded to other element. In addition, for the secondary batteries, the initial charge capacity and the cycle characteristics were examined in the same manner as that of Examples 1-1 to 1-7. The results are shown in Table 11 and FIG. 15.

As evidenced by Table 11 and FIG. 15, in Examples 7-1 to 7-5 in which the half-width was 1.00 degree or more, the capacity retention ratio and the initial charge capacity were more outstandingly improved than that of Comparative examples 4-1 and 4-2 in which the half-width was less than 1.00 degree.

That is, it was confirmed that if the half-width was 1.00 degree or more, the capacity and the cycle characteristics could be improved.

Consequently, as evidenced by the results shown in Table 1 to Table 11, FIG. 8, and FIG. 10 to FIG. 15, it was confirmed that if the anode active material had the reactive phase capable of reacting with lithium or the like and in which the half-width of the diffraction peak obtained by X-ray diffraction of the anode active material (the peak observed at the diffraction angle 2θ of between 41 degrees and 45 degrees) was 1.0 degree or more; the anode active material contained at least tin, iron, cobalt, and carbon as an element; the carbon content was in the range from 11.9 wt % to 29.7 wt %; the total ratio of iron and cobalt to the total of tin, iron, and cobalt was in the range from 26.4 wt % to 48.5 wt %; and the cobalt ratio to the total of iron and cobalt was in the range from 9.9 wt % to 79.5 wt %, the capacity and the cycle characteristics were improved.

The invention has been described with reference to the embodiment and the examples. However, the invention is not limited to the aspects described in the foregoing embodiment and the foregoing examples, and various modifications may be made. For example, in the foregoing embodiment and the foregoing examples, the descriptions have been given of the lithium ion secondary battery in which the anode capacity is expressed by the capacity based on insertion and extraction of lithium as a secondary battery type. However, the invention is not limited thereto. The secondary battery of the invention is similarly applicable to a secondary battery in which the anode capacity includes the capacity based on insertion and extraction of lithium and the capacity based on precipitation and dissolution of lithium, and the anode capacity is expressed as the total of the foregoing capacities by setting the charge capacity of the anode material capable of inserting and extracting lithium to the smaller value than the value of the cathode charge capacity.

Further, in the foregoing embodiment and the foregoing examples, the descriptions have been given of the secondary battery in which the battery structure is the cylindrical type, the laminated type, the sheet type, or the coin type; or the secondary battery in which the element structure is the spirally wound structure. However, the secondary battery of the invention is similarly applicable to a secondary battery having other battery structure as a button type secondary battery and a square type secondary battery; or a secondary battery having other element structure such as a lamination structure in which a plurality of cathodes and a plurality of anodes are layered.

Further, in the foregoing embodiment and the foregoing examples, the descriptions have been given of the case using lithium as an electrode reactant. However, the invention is applicable to a case using other Group 1 element in the long period periodic table such as sodium (Na) and potassium (K); a Group 2 element in the long period periodic table such as magnesium and calcium (Ca); other light metal such as aluminum; or an alloy of lithium or the foregoing elements. In this case, similar effects are obtainable. A cathode active material capable of inserting and extracting an electrode reactant, a nonaqueous solvent and the like may be selected according to the electrode reactant.

Further, in the foregoing embodiment and the foregoing examples, the appropriate ranges derived from the results of the examples have been described for the carbon content in the anode active material or the secondary battery of the invention. However, the descriptions do not totally deny the possibility that the content is out of the foregoing range. That is, the foregoing appropriate range is only the particularly preferable range for obtaining the effects of the invention. As long as the effects of the invention could be obtained, the carbon content may be slightly out of the foregoing range. This is not limited to the carbon content described above, but the same is similarly applied to the half-width of the diffraction peak obtained by X-ray diffraction (the peak observed at the diffraction angle 2θ of between 41 degrees and 45 degrees), the total ratio of iron and cobalt to the total of tin, iron, and cobalt, the cobalt ratio to the total of iron and cobalt, the content of aluminum or the like, the contrast of nickel or the like, the silver content and the like.

It should be understood by those skilled in the art that various modifications, combinations, sub-combinations and alternations may occur depending on design requirements and other factors insofar as they are within the scope of the appended claims or the equivalents thereof.

What is claimed is:

1. An anode active material containing, as an element, at least tin (Sn), iron (Fe), cobalt (Co), and carbon (C), wherein:
a carbon content is in the range from 11.9 wt % to 29.7 wt %, a total ratio of iron and cobalt to a total of tin, iron, and cobalt is in the range from 26.4 wt % to 48.5 wt %, and a cobalt ratio to a total of iron and cobalt is in the range from 9.9 wt % to 79.5 wt %;
a reactive phase capable of reacting with an electrode reactant is included; and
a half-width of a diffraction peak obtained by X-ray diffraction (peak observed at diffraction angle 2θ of between 41 degrees and 45 degrees) is 1.0 degree or more.

2. The anode active material according to claim 1, wherein 1s peak of the carbon is obtained in a region lower than 284.5 eV by X-ray Photoelectron Spectroscopy.

3. The anode active material according to claim 1 further containing, as an element, at least one selected from the group consisting of aluminum (Al), titanium (Ti), vanadium (V), chromium (Cr), niobium (Nb), and tantalum (Ta).

4. The anode active material according to claim 1 further containing, as an element, at least one selected from the group consisting of nickel (Ni), copper (Cu), zinc (Zn), gallium (Ga), and indium (In).

5. The anode active material according to claim 1 further containing, as an element, at least one selected from the group consisting of aluminum, titanium, vanadium, chromium, niobium, and tantalum; and at least one selected from the group consisting of nickel, copper, zinc, gallium, and indium.

6. The anode active material according to claim 5, wherein a content of at least one selected from the group consisting of aluminum, titanium, the vanadium, chromium, niobium, and tantalum is in the range from 0.1 wt % to 9.9 wt %.

7. The anode active material according to claim 5, wherein a content of at least one selected from the group consisting of nickel, copper, zinc, gallium, and indium is in the range from 0.5 wt % to 14.9 wt %.

8. The anode active material according to claim 1 further containing silver (Ag) as an element.

9. The anode active material according to claim 8, wherein a silver content is in the range from 0.1 wt % to 9.9 wt %.

10. The anode active material according to claim 1 further containing, as an element, at least one selected from the group consisting of aluminum, titanium, vanadium, chromium, niobium, and tantalum; at least one selected from the group consisting of nickel, copper, zinc, gallium, and indium; and silver.

11. A secondary battery comprising a cathode, an anode and an electrolyte, wherein:
the anode contains, as an element, an anode active material containing at least tin, iron, cobalt, and carbon;
a carbon content in the anode active material is in the range from 11.9 wt % to 29.7 wt %, a total ratio of iron and cobalt to a total of tin, iron, and cobalt is in the range from 26.4 wt % to 48.5 wt %, and a cobalt ratio to a total of iron and cobalt is in the range from 9.9 wt % to 79.5 wt %;
a reactive phase capable of reacting with an electrode reactant is included; and
a half-width of a diffraction peak obtained by X-ray diffraction (peak observed at diffraction angle 2θ of between 41 degrees and 45 degrees) is 1.0 degree or more.

12. The secondary battery according to claim 11, wherein 1s peak of carbon is obtained in a region lower than 284.5 eV by X-ray Photoelectron Spectroscopy.

13. The secondary battery according to claim 11, wherein the anode active material further contains, as an element, at least one selected from the group consisting of aluminum, titanium, vanadium, chromium, niobium, and tantalum.

14. The secondary battery according to claim 11, wherein the anode active material further contains, as an element, at least one selected from the group consisting of nickel, copper, zinc, gallium, and indium.

15. The secondary battery according to claim 11, wherein the anode active material further contains, as an element, at least one selected from the group consisting of aluminum, titanium, vanadium, chromium, niobium, and tantalum; and at least one selected from the group consisting of nickel, copper, zinc, gallium, and indium.

16. The secondary battery according to claim 15, wherein a content of at least one selected from the group consisting of aluminum, titanium, vanadium, chromium, niobium, and tantalum in the anode active material is in the range from 0.1 wt % to 9.9 wt %.

17. The secondary battery according to claim 15, wherein a content of at least one selected from the group consisting of nickel, copper, zinc, gallium, and indium in the anode active material is in the range from 0.5 wt % to 14.9 wt %.

18. The secondary battery according to claim 11, wherein the anode active material further contains silver as an element.

19. The secondary battery according to claim 18, wherein a silver content in the anode active material is in the range from 0.1 wt % to 9.9 wt %.

20. The secondary battery according to claim 11, wherein the anode active material further contains, as an element, at least one selected from the group consisting of aluminum, titanium, vanadium, chromium, niobium, and tantalum; at least one selected from the group consisting of nickel, copper, zinc, gallium, and indium; and silver.
